(19) United States
(12) Patent Application Publication
(10) Pub. No.: US 2003/0104859 A1
(43) Pub. Date: Jun. 5, 2003

(54) Random number generator security systems

(76) Inventor: David Chaum, Sherman Oaks, CA (US)

Correspondence Address: DAVID CHAUM, 14652 SUTTON ST., SHERMAN OAKS, CA, 91403, US

(21) Appl. No.: 10/310,210

(22) Filed: Dec. 5, 2002

Related U.S. Application Data
(60) Provisional application No. 60/338,472, filed on Dec. 5, 2001.

(51) Int. Cl. A63F 9/24; A63F 13/00; G06F 17/00; G06F 19/00

(52) U.S. Cl. 463/22

(57) ABSTRACT

Random number generation and systems for their use are disclosed in which parts of some contributing values are committed to or hidden or uncontrollable before they are revealed or combined. Plural parties generally contribute to the process of developing the random values and in some exemplary systems incorporating the random generator concepts other parties perform and verify the operation of the system. In some preferred embodiments, commitments or physical locking are believed to impede various cheating and collusion strategies. In other exemplary embodiments values that are committed to by a system remain hidden while a user influences other values that are ultimately combined with committed values to determine the results. In some further exemplary embodiments users of ordinary skill are able to control their contributions and in other examples users are believed to be unable to deliberately choose their contribution. Overall systems include capabilities to allow efficient communication and audit while protecting against fraud and ensuring privacy.

### BACKGROUND OF THE INVENTION

1. Field of the Invention

The present invention relates generally to random number generation systems, and more specifically to providing security in such systems.

2. Description of Prior Art

The present application claims priority from a U.S. Provisional Application, by the present applicant, titled “Random number generator security systems,” U.S. PTO No. 60/338472, Nov. 5, 2001.

The generation of so called “random” numbers is a critical part of many gaming and other systems (including all manner of games, lotteries and even mandated in voting machines conforming to Federal Election Commission “standards”) in which security against various abuses can be of significant concern. Known systems for these application areas address potential abuse ineffectively, often by visible mechanism and by accounting-type controls.

In traditional systems, random number generation is done in a way designed to be visible to and engender the trust of observers. For instance, cards are shuffled, dice are rolled, wheels are spun, and balls are chaotically mixed. Such macro physical mechanical “experiments,” although visible, produce relatively poor quality random numbers at relatively high cost and low speed (compared to such generators as those based on invisible effects like so-called “thermal noise” used in simple electronic generators today). A more fundamental problem is that technological advance makes it easier for macro physical experiments based to be deceptive, secretly manipulated, influenced or predicted in advance. Furthermore, cost, robustness, and difficulty of interfacing contribute to making such systems impractical for large-scale use in devices such as slot or poker machines. Moreover, lack of common venue has made them inapplicable, or at least less convincing, for many multi-player, progressive, or online settings.

In more modern systems, random numbers are typically created automatically and in a way that is invisible to users, which brings its own set of problems. Observers can see neither the noise process itself nor the means by which the random number is presumably extracted from the noise. Such systems typically also include microprocessors in their inner workings, which are not only hard to observe, but have structure that is often too complex to analyze in practice.

Five kinds of abuse of gaming machines are distinguished here as examples as will be appreciated for concreteness:

Low-payout distribution—Well-known cheating techniques include loaded dice, stacked decks, and slot machines that pay out less than they should.

Manipulation by skill of the user—Magicians are reputed to be able to flip coins in ways that give them surprising control over the outcome, for example, and it is believed that certain individuals were able to obtain better than expected results on mechanical slot machines through very skillful operation of the lever.

Influencing the mechanism—Slot machines that can be predicted or triggered are known from fraud reported in the press, perhaps not as well, though, as the roulette table at “Rick's” in the film “Casa Blanca” (a variant of this allows the random number generator to be made at least somewhat predictable by not protecting against failures or improper signal levels, such as low voltage or injection of signals that are to be generated “randomly” internally).

Leaking of information—The visible numbers on lottery tickets that allow tickets with winning codes under latex have been leaked, sometimes causing whole issues of tickets to be withdrawn as has been reported recently in the press.

Low-payout distributions are effectively addressed by accounting techniques. User-skill is mooted by most modern gaming machines where user input presumably has little to do with payout probabilities. Influencing may be hidden in software of gaming machines; leaking may be by out-of-band signals, such as pre-arrangement or radio emanations, or through use of the display, such as an outcome that signals a big payout multiple for near future bets. Influencing and leaking typically are enormously facilitated by collusion between the player and those able to influence the structure and/or software of machines. Signaling can be detected when outcomes are committed to in advance, but this requires checking the commitments in case of wins and losses as well as keeping the values committed to secret.

An example of accounting-style controls is slot machines or Internet gaming systems, even in some of the most highly-regulated environments, only provide information on the amount of money received and paid out and perhaps the random values themselves. Some regulators actually go so far as to enforce the distribution at the expense of partial leaking, such as by using up table of outcomes in random order before proceeding to the next table. What is missing in such systems is a way to ensure that the random values used cannot, even in case of collusion, be manipulated or predicted. Those able to benefit from winning values, by signaling and/or leaking attacks, can fool regulatory authorities and profit at the unwitting expense of other parties including the public and even operators.

Some variations are known in the prior art. For instance, a technique in the gaming folklore lets each of two parties supply their own die, both dice are rolled, and then the face values are added modulo 6 to determine the combined outcome. If one party has a “loaded” die, that is one that has other than the expected distribution, such as one that is substantially biased towards particular outcomes, then the effect of this is removed if the die of the other party is fair.

Walker, et al. in U.S. Pat. No. 6,010,404, issued Jan. 4, 2000 states “Many gamblers superstitiously believe that when they are feeling ‘lucky’ they are sure to win. In casino games which allow players to add their personal input into the games, the players often believe that their ‘lucky’ feelings are transferred to the objects of their input and that they can therefore somehow ‘control’ the outcome of the game . . . . Of course such efforts to ‘control’ the outcome of these games, unless cheating is employed, is purely illusory. However, it is this ‘illusion of control’ that adds to player enjoyment, and in some cases is a primary attraction for these games.” Disclosed there are means where a biometric or user gesture is combined with an electronically generated random number that is then used to determine the outcome of a game. Another example along similar lines know in the prior art for user influence comprises dice that can be “thrown” by users and whose resting position is then sensed. Such devices use special tokens including magnetic elements to allow sensing. An advertised feature of such devices is, however, that the magnetic properties can be used to influence the probabilities including using the sensing coils for that purpose.

Much is known about the generation of random values. One kind of source, already mentioned, is raw values generated from noise, examples of which are thermal and quantum noise; such generators can be called “micro” or “invisible” in that the structures generating the random values are too small for people to see. The output of raw generators can often be improved by appropriate algorithmic transformations, as is known in the art. For instance, Turing is credited with the idea that to remove a fixed bias from a series of independent coin flips, like pairs are discarded and pairs with differing outcomes each determine a single output bit. Known results generalize such techniques. Cryptographic whitening functions are intended to both mix and make analysis difficult for cheaters. So called “pseudorandom” generators produce sequences of values from a starting seed. Cryptographic whitening and pseudorandom sequence blur when they are combined, such as a sequence algorithm that continually folds in new raw quantum generated bits.

Techniques to provide a kind of “fail-secure” operation of random number generators are provided in some sophisticated systems. For instance, circuits monitoring various parameters of random number generators are allowed to trigger alarms if those parameters should go out of range. Some designs allow values of a parameter to fluctuate but compensate by having a part that is influenced in one direction by the fluctuation and another part that is influenced in the opposite direction by the same fluctuation. Also, shielding, filtering and conditioning against external signals are known. These can be thought of as aimed against deliberate or accidental influencing. Moreover, devices to detect failure of the generator itself are sometimes employed, such as by making simple statistical tests and raising an alarm if failures go beyond some predetermined threshold. Moreover, cryptographic pseudorandom sequences based on secret keys can be folded in to provide a sort of fall-back worst-case randomness in the output.

So called “coin-flipping protocols” allow participants to supply what is in effect an encrypted random element and, once these are supplied and agreed, the encryption keys are revealed and the random elements combined. A problem with this approach, however, is a subset of participants that waits to learn the keys of other participants can then compute the outcome and have the option of forcing a re-draw by not revealing one or more of their keys. Another problem is that it relies on cryptographic assumptions. A further problem is that it's two-round nature makes it slow for real-time applications.

The present invention aims, among other things, to provide security and fairness in systems using random numbers where outcomes have different consequences for different parties. Objects of the invention also include addressing all the above mentioned concerns as well as generally providing practical, secure, fair, influence-free, robust, verifiable, efficient, low-cost, and uniform random number generation and systems incorporating or using such numbers and practical applications including such systems. All manner of apparatus and methods to achieve any and all of the forgoing in gaming and in other applications are also included among the objects of the present invention.

Other objects, features, and advantages of the present invention will be appreciated when the present description and appended claims are read in conjunction with the drawing figurers.

### BRIEF DESCRIPTION OF THE DRAWING FIGURES

FIG. 1 is a combination block, flow, functional, and schematic diagram of an exemplary embodiment for obtaining a random number from visible and invisible sources in accordance with the teachings of the present invention.

FIG. 2 is a combination block, flow, functional, and schematic diagram of an exemplary embodiment for obtaining a random number using multiple invisible engines in accordance with the teachings of the present invention.

FIG. 3a and 3b show combination schematic, functional, plan and section view diagrams of an exemplary embodiment of a device for displaying the results of invisible sources in accordance with the teachings of the present invention.

FIG. 4 is combination flow and functional diagram of an exemplary embodiment for the manual use of a device for displaying the results of invisible sources in accordance with the teachings of the present invention.

FIG. 5a through 5c show, in different states, combination schematic, functional and plan view diagrams of an exemplary embodiment of a device for mechanically generating random or other numbers and cooperating display of invisible sources in accordance with the teachings of the present invention.

FIG. 6a through 6c show, in different states, combination schematic, functional, plan and section view diagrams of an exemplary embodiment of a device for displaying the results of invisible sources in accordance with the teachings of the present invention.

FIG. 7a and 7b show, in different states, combination schematic, functional, plan and section view diagrams of an exemplary embodiment of a device for mechanically generating random or other numbers and freezing same in accordance with the teachings of the present invention.

FIG. 8 is combination flow and functional diagram of an exemplary embodiment for mechanically generating random or other numbers and cooperating display of invisible sources in accordance with the teachings of the present invention.

FIG. 9 shows a combination flow, block, and functional diagram for an exemplary embodiment of an application including visible and invisible sources of random values and the use of communication means and calculation of outcomes, of some of the inventive techniques in accordance with the teachings of the present invention.

FIG. 10 shows a combination flow, block, and functional diagram for an exemplary embodiment of an application for gaming machines, of some of the inventive techniques in accordance with the teachings of the present invention.

FIG. 11 is combination flow and functional diagram of an application for gaming machines of some of the inventive techniques in accordance with the teachings of the present invention.

FIG. 12 is a combination flow, block, and functional diagram for an exemplary embodiment of a multiple generator technique in accordance with the teachings of the present invention.

FIG. 13 is a combination flow and functional diagram of an exemplary embodiment of a single generator within a multiple generator technique in accordance with the teachings of the present invention.

FIG. 14 is combination flow and functional diagram of an exemplary embodiment of a multiple generator technique in accordance with the teachings of the present invention.

FIGS. 15 and 16 are combination flow, block, and functional diagram for two configurations of on an exemplary embodiment of time-based random number generation in accordance with the teachings of the present invention.

FIG. 17 is combination flow and functional diagram of an exemplary embodiment of time-based random number generation in accordance with the teachings of the present invention.

FIG. 18 is a combination flow, block, functional and schematic diagram for an exemplary embodiment of a signature-based random number generator system in accordance with the teachings of the present invention.

FIG. 19 is combination flow and functional diagram of an exemplary embodiment of a signature-based random number generator system in accordance with the teachings of the present invention.

FIG. 20 is a combination flow, block, functional and schematic diagram for an exemplary embodiment of whitening in random number generation in accordance with the teachings of the present invention.

FIG. 21a through 21c are combination schematic, functional, plan and section view diagrams of an exemplary embodiment of a device for displaying and modifying the results of invisible sources in accordance with the teachings of the present invention.

FIG. 22 combination flow and functional diagram of an exemplary embodiment for the manual use of a device for displaying and modifying the results of invisible sources in accordance with the teachings of the present invention.

FIG. 23a through 23e are combination flow, block, functional and schematic diagrams for exemplary embodiments of elementary random number deriving systems in accordance with the teachings of the present invention.

FIG. 24a through 24f are combination flow, block, functional and schematic diagrams for exemplary embodiments of random number deriving application systems in accordance with the teachings of the present invention.

FIG. 25a through 25d, are combination, block, functional, schematic, plan view diagrams for exemplary embodiments of a visible motion quantum generator display and locking system in accordance with the teachings of the present invention.

FIG. 26 is a combination, block and flow diagram for exemplary embodiments of a visible motion quantum generator display and locking system in accordance with the teachings of the present invention.

FIG. 27a through 27c are combination, block, functional, schematic, plan view diagrams for exemplary embodiments of a user operable mechanical generator and locking system in accordance with the teachings of the present invention.

FIG. 28 is a combination, block and flow diagram for exemplary embodiments of a user operable mechanical generator and locking system in accordance with the teachings of the present invention.

FIG. 29 is a combination, block, functional, schematic, plan view diagrams for exemplary embodiments of a user operable mechanical generator and detector system in accordance with the teachings of the present invention.

FIG. 30 is a combination, block, functional, schematic, plan view diagrams for exemplary embodiments of system for accepting wagers, conducting experiments, and then making payouts in accordance with the teachings of the present invention.

### BRIEF SUMMARY OF THE INVENTION

This section introduces simplifications to allow some of the inventive concepts to be more readily appreciated, but makes significant simplifications and omissions for clarity and should not be taken to limit its scope in any way; the next section presents a more general view.

Random number generation and systems for their use are disclosed. Parts of some contributing values are committed to and/or hidden and/or uncontrollable before they are revealed or combined. In some embodiments, plural parties contribute to the process of developing the random values. In some exemplary systems incorporating the random generator concepts, additional parties perform and verify the operation of the system and preferably any party may verify its operation. In some exemplary preferred embodiments, commitments and/or physical locking are employed as they are believed to impede various cheating and collusion strategies. In some further exemplary embodiments values that are committed to by a system remain hidden while a user influences other values that are ultimately combined with committed values to determine the results. In yet other preferred exemplary embodiments users of ordinary skill are able to control their contributions and in other examples users are believed to be unable to deliberately choose their contribution. Audit of the overall process is provided for by commitments to wagers and payments that are then checkable afterwards, and in some embodiments hide some of the values committed to while still allowing audit.

Novel approaches to combining what should be random inputs of multiple parties into a common random value that can be more trustworthy are included. Some parties may offer their input as having come preferably from substantially “invisible” (that is unverifiable) experiments based it is believed on such phenomena as quantum and/or thermal and/or cosmic noise and/or chaotic phenomena. Other parties may be presumed to be able to determine their input at their own free choice. In some examples, optionally one or more parties are remotely located and one or more are present at one or more sites where the results will be determined.

On example of these inventive concepts includes a remote computation (whether distributed, such as a collection of entities, or monolithic) and a person in attendance at a location, such as for instance at a gaming machine. The person is able to witness and/or influence and/or determine the results of experiments, such as manually, that can alter the common result. One example of this is the person conducting an experiment while the contribution of the remote computation remains fixed. To the extent that the remote computation's input remains hidden, the person can be allowed to influence the experiment (though leaking of the hidden value becomes an issue). When the configuration is revealed, the combined value is determined in a pre-arranged manner, such as by combining two outcomes by a suitable mapping, such as an Abelian group operation. In some examples the outcome of the remote computation may be in the hidden configuration of certain elements and the person can further modify that configuration freely. When revealed, this modified configuration can determine the final common outcome. In other examples, one or more outcomes of remote parties remain hidden and fixed until they are revealed, potentially in stages, and combined with values potentially influenced, chosen, determined, and/or modified by one or more persons present. The combined value, potentially at each stage, can be determined in a pre-arranged manner that is itself optionally determined by the configuration of the system.

As a further illustrative concrete example, consider a lotto style game, where a public drawing of balls is wanted for reasons such as tradition and entertainment. Balls would be marked with special symbols. The balls would be placed in motion and then a set of values captured (and/or hidden) random values would be agreed. As the mechanical process completes, the captured values can be opened (and physical representations revealed). In the end, the mapping of the symbols from the balls to the traditional lotto number would be by a pre-determined combining with the captured values.

Invisible generation of random numbers can be accomplished by a single quantum generator or by cooperation of multiple generators. There can be advantage in plural parties each operating their own generator(s), including various processing to be described later, where the set of generators at a party can be called an “engine.” When multiple engines are involved, output of each would ideally be included in the combined result in such a way that each could change the combined outcome to any value but that the opportunity to cheat by influencing the outcome is limited as much as practical. The first property is readily addressed, such as for example in a system where each engine sends in a string of bits of a certain length to a common point that adds them modulo two thereby forming the combined binary-string output. Such a system would, however, allow the last engine to send in a value, if it were to have learned the outputs of the other engines before its own value is supplied, to adjust the combined output to any desired value. Relaxing the other requirement, if some engine(s) were unable to influence the output in certain ways, then those that can influence it in those ways might collude and deliberately do so.

A novel aspect of these systems disclosed is where each party has a connection to the summing point and sends bits that are timed accurately enough that there is not enough time for an intercepting party to use the intercepted bits to influence the bit that the intercepting party itself sends in. For instance, a central device is directly connected to engines arranged in a radial pattern and individual bits are sent in to it at precisely determined times. Another novel aspect is for each party to issue a uniquely invertible encryption of their contribution, where the effective key size is small enough that it can be recovered if the party backs out later, but is large enough that it is believed infeasible for a party to break the encryption of the output of other parties between when they can be learned and when its own output must be supplied. Parties that give improper input or stop can be left out of further rounds, but will not be able to change any outcome. A third aspect is not believed secure against collusion of a majority of participants, though it is believed robust against withdrawal of any minority. An example of this is a so-called “Verifiable secret sharing” of the keys needed to open a cryptographic “commitment” made by each participant. A fourth aspect lacks robustness but removes temporal factors, which can not only complicate and slow systems but can also call for additional security mechanisms such as timestamps. Each engine has a posted public key and a secret corresponding private key that it uses to sign unique requests for random numbers; combining these signatures yields the outcome.

In a first exemplary approach to enforce the security of a gaming transaction, the gaming machine first ensures itself that it has sufficient means to collect from the user, such as by credit, authorization, escrow or the like guaranteed by others and/or through its own means. Then it issues the play “definition” that defines how the random value is to be used to determine the outcome. In a non-temporal system, this is then supplied to the parties making the signatures, who sign and record the transaction. Later, any user choices are optionally provided and the corresponding settlement can be made. The records of the signers are preferably used to ensure a single settlement in case the gaming machine does not initiate it or initiates it more than once.

In a second exemplary approach to gaming transactions, the gaming machine protects itself against default of the player in whatever way as before and then issues a play definition to a timestamp facility. A random value released after the timestamp time is then used to determine the outcome, along with player interaction as before. Which time random value is used can be determined in the pay definition, in which case the timestamp must precede it and/or it can be determined by the timestamps. Cumulative or chained timestamping techniques yield has values that depend on the prior history; such values are used in some embodiments as what is signed.

In an overall wagering system, as an example application, wagers are assigned unique identifiers and descriptions and posted. Auditability is provided to ensure that the total amount wagered has been provided. Some parts of the posted information are in some preferred embodiments encrypted; if they are not to be decrypted, various properties about them can be proved by so-called zero-knowledge and/or minimum disclosure proof techniques, optionally incorporating special variations to improve efficiency.

### GENERAL DESCRIPTION

Some novel techniques presented here include what will be called a “quantum generator,” preferably based on phenomena such as quantum noise and/or thermal noise and/or cosmic noise and/or chaotic phenomena, cooperating with a way to display a what will be called a “quantum outcome”. This may also be referred to as an “invisible” source of randomness, in the sense that people cannot readily verify its operation. A visible what will be called here “mechanical generator,” preferably based on humanly-observable physical experiments such as those involving chaotic or hard to predict movement of labeled objects (but also user influenceable and even settable in some embodiments), is also operated and results in what will be called a “mechanical outcome”. The results are combined in a pre-arranged manner, such as addition in the group from which the two elements are chosen.

The display of the quantum outcome is said to be “captured” in a form that cannot readily be changed without being readily noticed by observers, such as printing or positioning of macro objects. The quantum outcome can also be what is called “hidden” from the user and therefore not readily recognizable by the user, but preferably still verifiably captured, substantially before completion of the mechanical experiment and revealed afterwards (which is intended to prevent manipulation of the mechanical outcome responsive to the quantum outcome). A means to ensure that the result of the mechanical experiment is captured before the hidden quantum outcome is revealed is preferably provided (so that the mechanical experiment cannot be tampered with to advantage). Also the “sequencing” of events in some embodiments is enforced (such as to ensure that the mechanical experiment substantially cannot be re-visited after the quantum outcome is revealed). The status of the overall process is preferably what will be called “visible” to the observer, such as by the position or arrangement of physical elements or displays. The results are combined in some embodiments automatically, by calculation verifiable by an observer, by virtue of how they are displayed, or even inherently when the object recording the quantum outcome is itself then manipulated to reflect a change due to the mechanical outcome.

Some example embodiments are intended for what will be called “supervised” operation, where the mechanical outcome is handled outside the control of the automated system controlling the quantum contribution. Other example embodiments combine the mechanical and quantum processes in a single physical device, such as with mechanical coupling for sequencing. A further example embodiment uses signals sent between substantially separate devices for sequencing.

Various extensions and embellishments are also anticipated. The mechanism preferably, for example, are able to reset conveniently for the next go round, such as by a rotational arrangement that returns to the starting point. The mechanical outcome can be captured electronically. Also, the mechanical, quantum and/or a combined outcome can then additionally be sent in an authenticated form. Provision can be made for incorporation of values that determine which experiment will be made or how results will be determined, possibilities for a draw and re-do of an event, and all manner of continuing cumulative chaining, splitting and joining of event streams.

What will be called generally “whitening” can be applied at various points in substantially all the approaches, often being omitted for clarity. An example is one-to-one or uniformly many-to-one functions, preferably cryptographically complex and preferably one-way. Such functions can be applied to the output of each engine and to any combined result. One advantage of this approach is that it is believed to make ineffective partial manipulation of values by engines. For instance, without such functions, being able to determine the least significant bit of the signatures by the engines in a scheme where the raw signatures are exclusive-OR'ed bit-wise is believed to allow an outcome with a chosen bit. Similarly, the “folding in” of cryptographic transformations provides additional protections as are known.

### DETAILED DESCRIPTION OF PREFERRED EMBODIMENTS

Detailed descriptions are presented here sufficient to allow those of skill in the art to use the exemplary preferred embodiments of the inventive concepts.

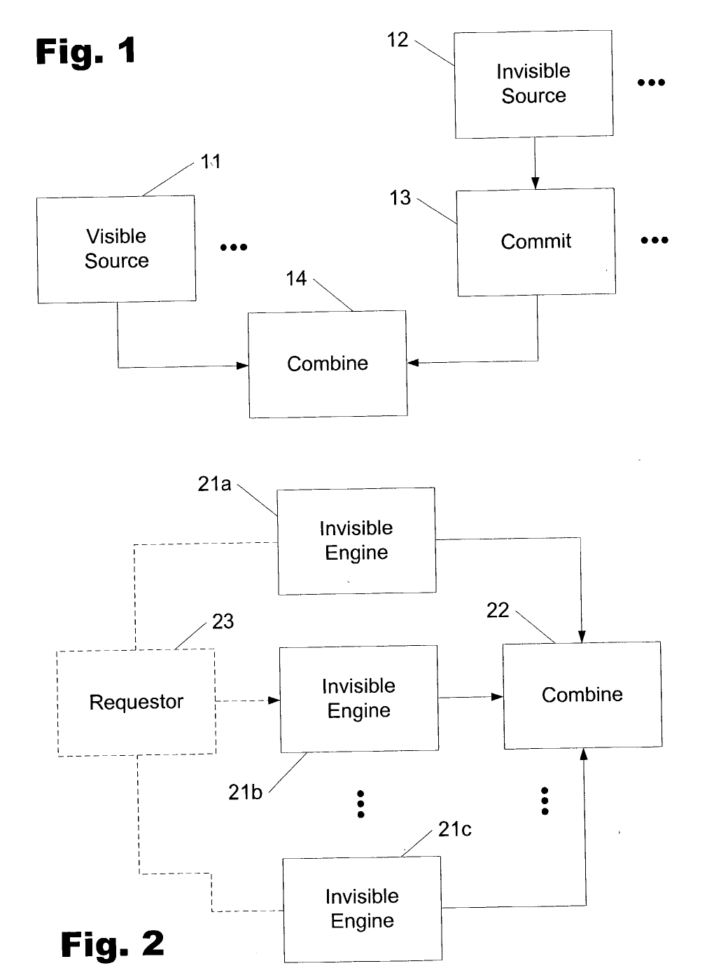

Turning now to FIG. 1, a combination block, flow, functional, and schematic diagram of an exemplary embodiment for obtaining a random number from visible and invisible sources in accordance with the teachings of the present invention will now be described. One source of random numbers whose operation can be seen by human observers, such as dice, balls or wheels, are shown as visible source 11. A second source of random numbers that is not generally visible to human observer, such as a quantum generator outcome, is shown as invisible source 12. Each source can be realized as a combination of plural generators and/or engines, and plural instances of each can be used as indicated by the ellipsis. The output of invisible source 12 is frozen and hidden by the commit 13, such as by, behind a shutter, a physical register that is kept from changing state by the position of an element whose position is visible from outside. When the commit is opened, such as by moving the element freezing its position, preferably after visible source 11 has produced it output, the output of invisible source 12 is provided as the second input to combine 14. The first input to combine 14 is from visible source 11. The output of combine 14 is preferably an element of the same Abelian group, such as bit strings under addition modulo two, as the outputs of visible source 11 and invisible source 12, where the combine 14 output is the group operation of its two inputs.

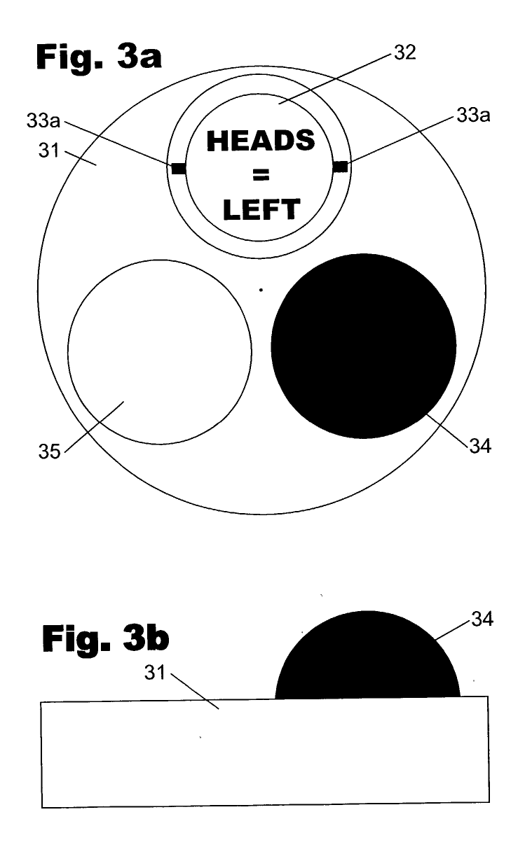

Referring now to FIG. 2, a combination block, flow, functional, and schematic diagram of an exemplary embodiment for obtaining a random number using multiple invisible engines in accordance with the teachings of the present invention. One or more invisible engines 21a through 21c are arranged to contribute their output to combiner 22. The dashed lines show part of the system that is used in some embodiments and comprise requestor 23 providing requests to the engines 21a-c. In some embodiments the requested values are signatures issued by invisible engines 21a-c that are then combined by any combiner 22.

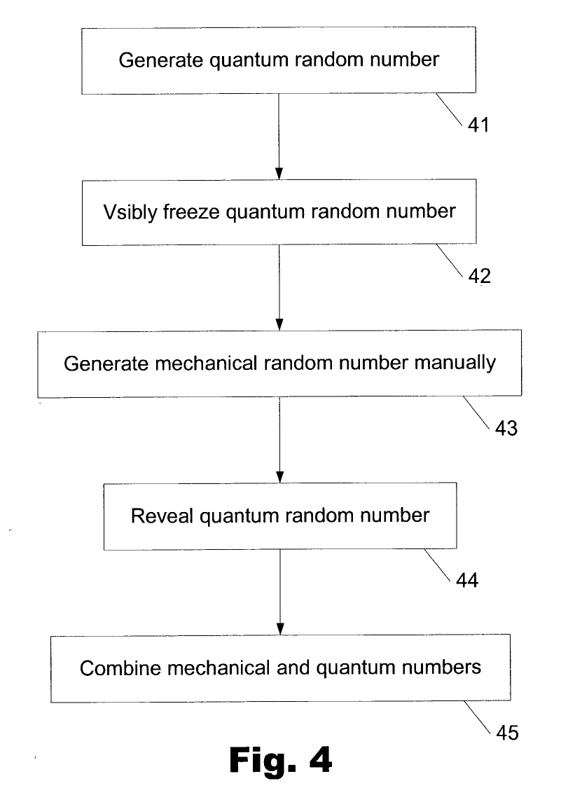

Turning now to FIG. 3a and 3b, combination schematic, functional, plan and section view diagrams of an exemplary embodiment of a device for displaying the results of invisible sources in accordance with the teachings of the present invention is shown. In particular, FIG. 3a shows a plan view from the front and FIG. 3b shows a section through a plane perpendicular to the plan view. The main body disc 31 is preferably opaque, but has a transparent window through which wafer 32 is seen. Wafer 32 is mounted on pins 33a and 33b so as to be able to rotate about the axis through them. When disc 31 is rotated about its center in plane of FIG. 3a so that wafer 32 is behind dome 34, then wafer 32 is free to so rotate, but when disc 31 and wafer 32 are in other relative positions, wafer 32 is substantially unable to rotate at least to the extent that it is unable to change the face that will be displayed through the window. Opaque position 35 explicitly indicates, though only for clarity, a position where wafer 32 would be hidden and unable to rotate.

Wafer 32 bears visible indicia preferably different on each side. In the exemplary embodiment, the side shown reads “HEADS=LEFT,” and the backside would then read “HEADS=RIGHT”. The meaning is that if a coin is flipped manually, as will be described, and then wafer 32 is revealed, it indicates that the outcome of the combined experiment should, in its shown configuration, be left if the coin landed heads and right if the coin landed tails; but, if the wafer were flipped the other way round, then a heads would yield right as outcome and a tails would yield left. The coin-flip outcome is replaced by user choice.

In operation, wafer 32 would be positioned under dome 34 and rotated to a position determined by a random source, such as are described elsewhere here, and then it would be positioned under opaque part 35 where it would be verifiably restrained from being able to rotate to another position. Once the mechanical experiment of determining a value, such as flipping a coin in the example, is completed, the wafer and its position can be revealed through the window. Then the outcome can be computed from the indicia exposed and the outcome of the mechanical experiment, as already described.

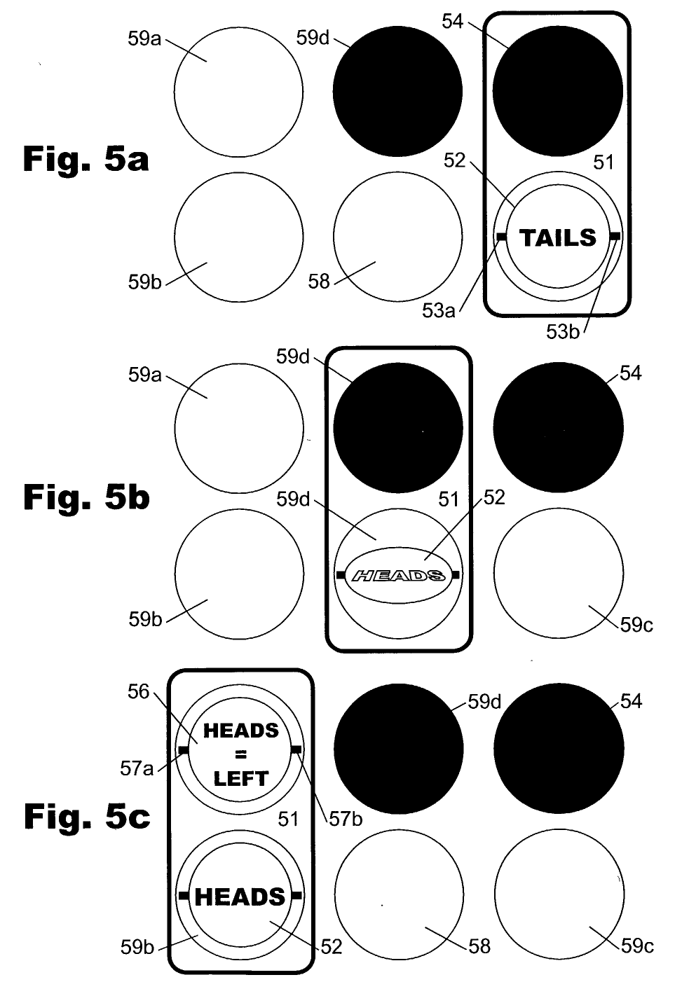

Turning now to FIG. 4, shown is a combination flow and functional diagram of an exemplary embodiment for the manual use of a device for displaying the results of invisible sources in accordance with the teachings of the present invention. Box 41 indicates that a first step is the generation of a first random number by an invisible process, such as are described here. This value is then frozen, as indicated in box 42, so that it cannot be readily changed without the opportunity to change being visible to observers. Preferably after this, box 43 indicates that a second value would be generated mechanically, such as by a random number generator, or in some uses the value could be chosen by a user. Once the second value is established, as indicated in box 44, the first value can be revealed, such as by opening a shutter or replacing an opaque element by a window. As indicated in box 45, the first and second values are combined, such as according to indicia on the display of one of the values as shown in FIG. 3.

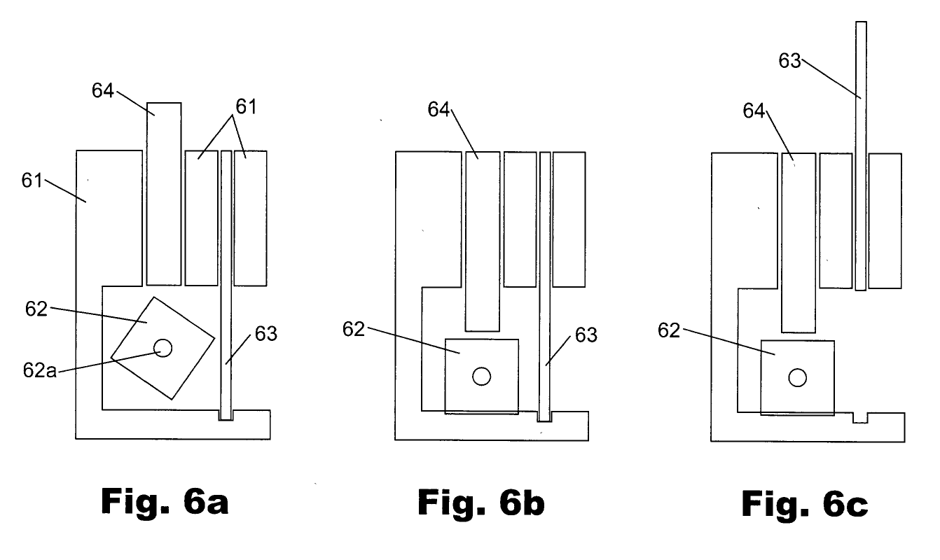

Turning now to FIG. 5a through 5c, shown in different states, combination schematic, functional and plan view diagrams is an exemplary embodiment of a device for mechanically generating random or other numbers and cooperating display of invisible sources in accordance with the teachings of the present invention. In particular, FIG. 5a shows a device in a first state, FIG. 5b shows it in a second state, and FIG. 5c shows it in a third state. The three states correspond to the three states of the mechanism of FIG. 3, which can be seen in the upper of the two rows, and can for example also be used as described with reference to FIG. 4. The lower of the rows is for the manual or mechanical generator. The three configurations can be switched between, for example, by sliding frame 51 shown relative to the underlying support, not shown, of the wafers. In another example, the surface shown is wrapped around joining the two sides at the back of a cylinder that rotates relative to an inner and preferably hollow (to make the trapping of wafer 56 easier to verify) cylindrical support. In whatever arrangement, a non-reversible ratchet mechanism would preferably prevent backwards motion during use.

Referring to FIG. 5a, the configuration reveals the manual/mechanical lower wafer 52, on pivots 53a and 53b, bearing indicia shown as “TAILS”, although this could also be hidden in this state. Dome 54 protrudes to allows upper wafer 56 to rotate on pivots 57a and 57b (all hidden in the instant view but exposed in FIG. 5c) and be arranged by motor means not shown for clarity to a position determined preferably by a quantum random source system, as described elsewhere here. Referring to FIG. 5b, frame 51 is shown over transparent dome 58 and wafer 52 is shown able to rotate, such as by mechanical and/or manual means not shown for clarity. Finally, referring to FIG. 5c, frame 51 is shown over transparent windows 59a and 59b, thereby revealing wafer 56 mounted on pins 57a-b, as already described, but frozen against rotation by window 59a. Similarly, wafer 52 is shown frozen by window 59b.

Operation begins with the first configuration, FIG. 5a, in which upper wafer 56 is positioned to reflect the hidden random source and the lower wafer is visible through window 59c, though it could also be free to rotate if dome 58 were extended. In the second state; upper wafer 56 is frozen by opaque window 59d and lower wafer 52 is rotated as part of a mechanical random number generator and/or manually made to have a chosen face forward. Then the third configuration freezes and exposes wafer 52 through window 59b and retains wafer 56 in its previously frozen position while making it visible through window 59a. Wafer positions reader(s) not shown for clarity can optionally reveal the position of at least the lower wafer and, if not determined by the motor means not shown, the upper wafer as well. The combination of the two wafer positions can be readily computed by an observer and/or automatically when the wafer positions are known to the computing means.

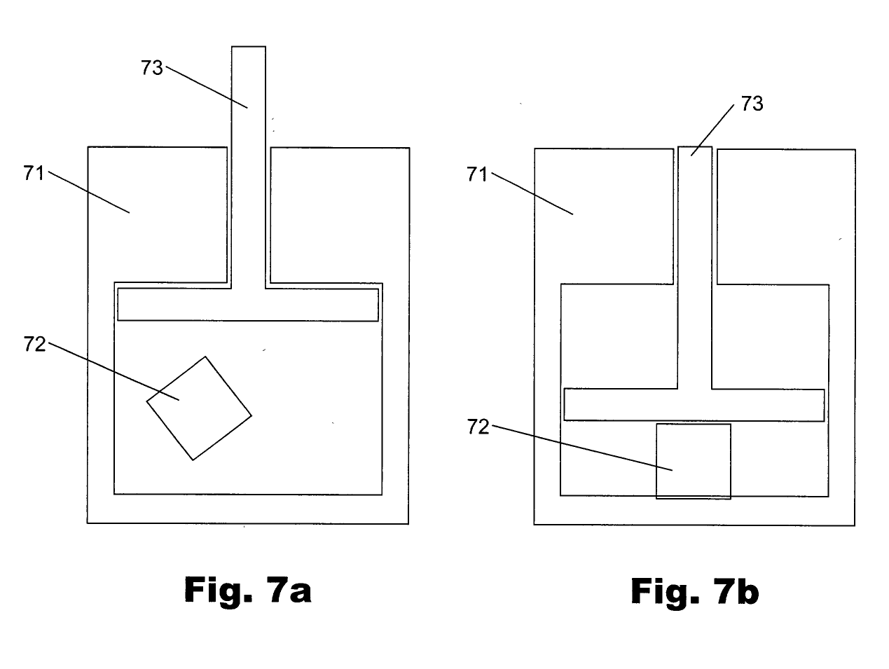

Turning now to FIG. 6a through 6c, shown in different states are combination schematic, functional, plan and section view diagrams of an exemplary embodiment of a device for displaying the results of invisible sources in accordance with the teachings of the present invention. States one through three are shown in FIG. 6a through FIG. 6c, respectively, substantially corresponding to the states of same number already mentioned with reference to FIG. 3 and FIG. 5, is substantially the same. Not shown for clarity are means, such as well known solenoids, linear motors, or whatever, to move the three elements 62-64 between the positions shown, under control of whatever information processing technology.

Referring now to FIG. 6a, a preferably opaque body 61 is shown containing movable indicator 62, which can be a rectangular cylinder that can be rotated around the center point 62a by a stepper motor or the like to position the indicator with indicia chosen by the invisible random source, as described elsewhere. It will be appreciated that the shaft is shown able to bend or move upward (relative to the configuration shown in FIG. 6b and 6c, to be described) to provide the rotation as shown. Shutter 63 in the position shown preferably blocks view or other access to the indicator from outside.

Referring to FIG. 6b, restrainer 64 is shown moved into the cavity of body 61 in such a way as to substantially block the rotation of indicator 61 and thereby freeze the value that would be displayed if shutter 63 were removed. As will also be appreciated, the part of restrainer 64 protruding (and preferably other parts as well) can readily be seen and verified from outside as being configured to freeze indicator 62.

Referring finally to FIG. 6c, retainer 54 remains in the position of FIG. 6b, but shutter 63 is moved into the open position, exposing indicator 62 to view. Before the next draw, the configuration is returned to that described with reference to FIG. 6a.

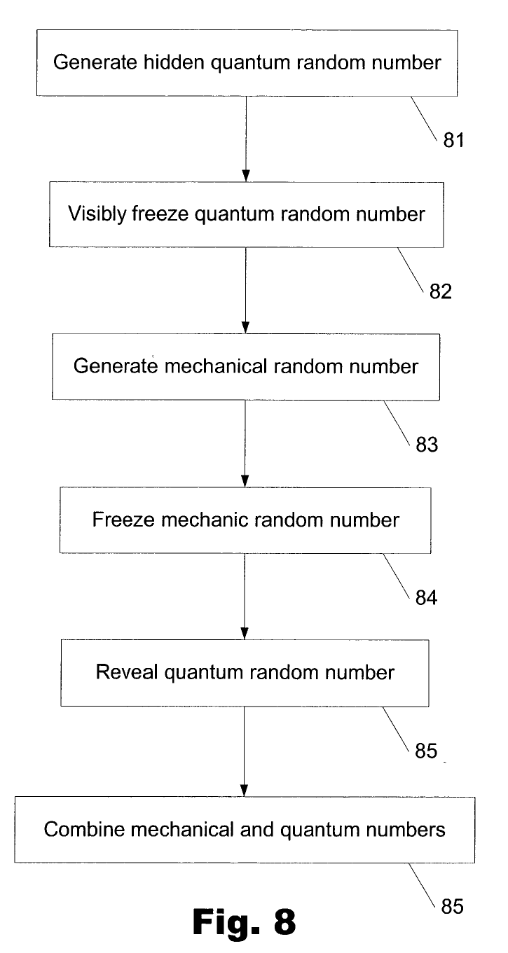

Turning now to FIG. 7a and 7b, shown in different states are combination schematic, functional, plan and section view diagrams of an exemplary embodiment of a device for mechanically generating random or other numbers and freezing same in accordance with the teachings of the present invention. Two states are shown. The first shown, FIG. 7a, corresponds to the first two of already described FIG. 3 and FIG. 5. As will be appreciated, this suggests, as already mentioned, that those two states of FIG. 5 could be combined as far as the lower row. The second, that of FIG. 5b, corresponds to the third state of FIG. 5. In operational use the states are used in substantially the same way. Preferably transparent body 71 encloses moveable element 72 bearing various indicia not shown for clarity. It can, for example, be a die, such as a regular polyhedron or other shape. In the configuration of FIG. 7a plunger 73 is configured to allow element 72 to move and obtain a random position through energy or movement induced automatically and/or by one or more users. In the configuration of FIG. 7b plunger 73 is configured to substantially restrain element 72 from moving sufficiently to change the face selected by its position, such as the upward facing face. It is preferable in some applications that the user be able to pick the device up and shake or otherwise manipulate it, so that the user can either casually cause a random face up or, if wished, a chosen face up. But at a certain moment the choice is frozen by entry to the state of FIG. 6b. Optional sensors for reading the position of element 72 and/or the configuration of plunger 73 are not shown for clarity. As will be appreciated, this feature of locking the mechanical source is believed not be required in certain applications, such as with a human observer, although it is believed to offer some advantage of definiteness and dispute avoidance even in such uses.

A particular variant of the mechanisms of FIGS. 3, 5, 6, 7, not shown for clarity, can use colored filters and corresponding multiple colored indicia to in known fashion make one part of the indicia more readily apparent under one color filter and a second (or lack of) indicia under a second color, and so forth. For instance, element 62 of FIG. 6 can allow viewing through one color filter in one configuration and as second color in another configuration. Die 72 would then have different indicia on each face, a first indicia visible under one color filter and a second under the second, and so forth. In an example alternate configuration, not shown in detail for clarity, such filters each cover roughly half of an otherwise clear domed object as would a shutter layer; the other half of the object being preferably opaque. One or die or dice are contained moveably within the dome. Sensors could allow opening of the shutter once the dice were in a stable position for a period of time suggestive of finality to the user or, for instance when the device is placed down on the table, or when certain mechanical buttons are released by the user (such as squeezing the dome down to allow the dice to be shaken. In some embodiments the particular filter that will be used would be frozen while a shutter is closed, but then the dice could be viewed through a cutout in that filter. The filters can also optionally be arranged in a hidden space such that which one could come out would be determined by their positions. For instance, the two might have orthogonal axis of rotation to come up and cover the upper half of the sphere; they would rotate so that one was oriented so it could come up, the other would be blocked. A double pivot like used in a gimbal is used.

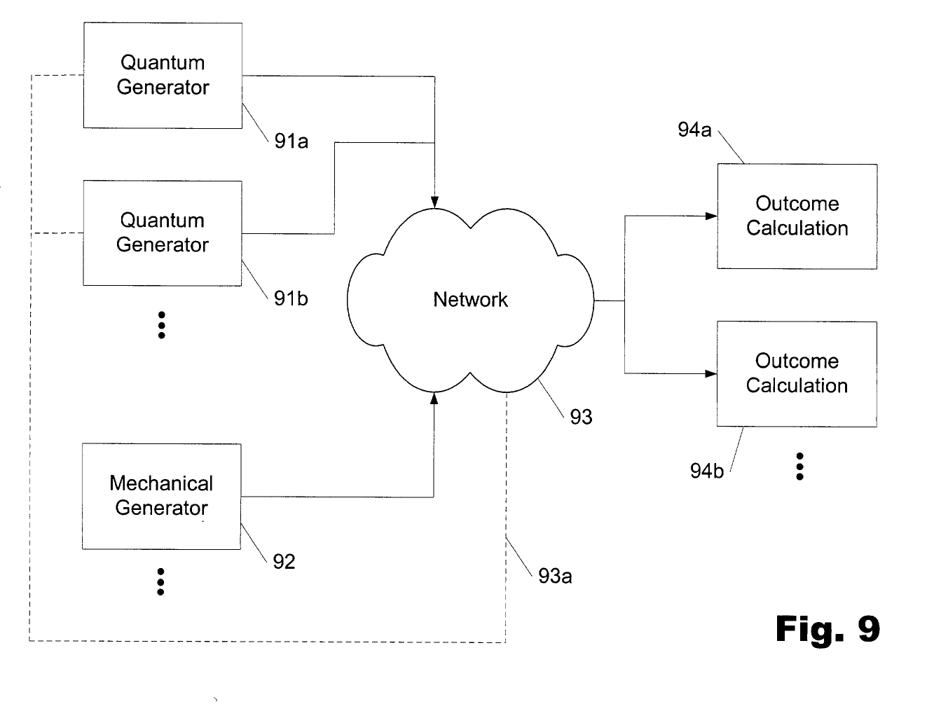

FIG. 8 is a combination flow and functional diagram of an exemplary embodiment for mechanically generating random or other numbers and cooperating display of invisible sources in accordance with the teachings of the present invention. In particular, it can as one example apply to exemplary operation of FIG. 5 as well as to a suitably controlled combination of FIG. 6 and FIG. 7. The first box 81 indicates that a first and preferably random value is obtained in a not-necessarily user visible way. Then, as indicated in box 82, the first value is frozen or mechanically committed, by whatever means such as printing and/or positioning of mechanical elements. Preferably after box 82, but also potentially in another order, box 83 shows the generation of a second value preferably by means visible to and optionally controlled or potentially influenced by one or more persons. Box 84 shows an optional freezing of the second value. As already mentioned, this can be to help create certainty or avoid disputes. Box 85 is the making visible or otherwise known the first number to the users, which should take place after at least box 83 has completed at least for a part. Finally box 86 is the combining of the first and second value, automatically and/or manually, in whatever pre-arranged manner. Preferably, the combining should allow all meaningful values of combined output to be generated for each value of one value by varying the other value. A uniform probability distribution for the outcome is also preferable for many anticipated applications.

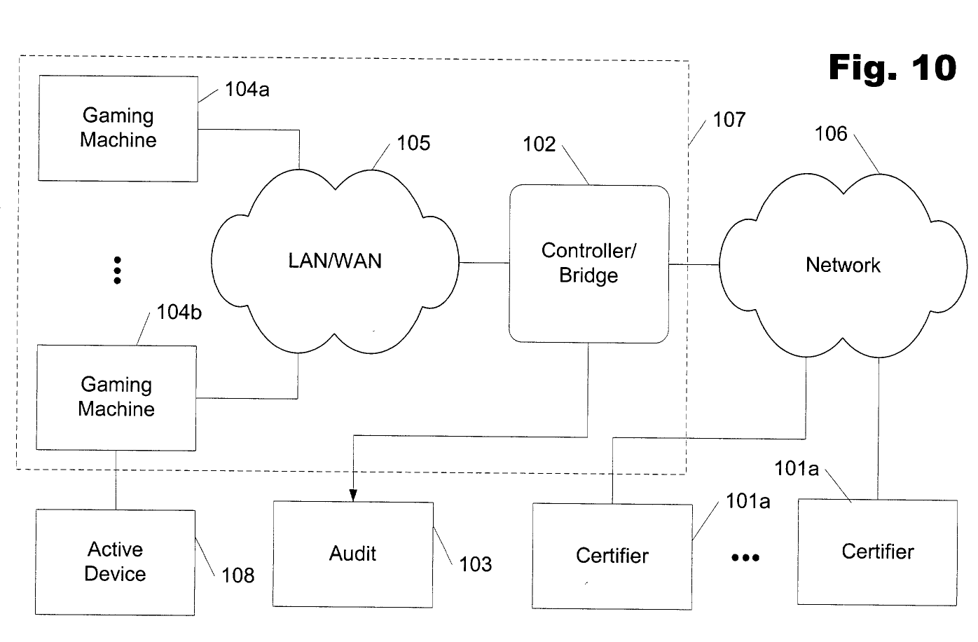

Turning now to FIG. 9, shown is a combination flow, block, and functional diagram for an exemplary embodiment of an application including visible and invisible sources of random values and the use of communication means and calculation of outcomes, of some of the inventive techniques in accordance with the teachings of the present invention. Parts of the embodiment disclosed might be used, for example and without limitation, to provide enhanced security of such games as lotto or bingo. Consider examples with one or more invisible first sources, examples for instance based on quantum generators as described elsewhere, and shown as 91a and 91b with ellipsis. Also consider one or more second sources, shown as 92 with ellipsis, such as mechanical or otherwise human visible sources of random numbers as known in the art and also mentioned elsewhere here. Transferring outcomes and optional cooperation of the first and second sources is accomplished by data communication means, shown for illustrative purposes as a network 93, though any combination of data transfer means whether internal, local, or wide area could be used. Outcomes are calculated by one or more means, shown as 94a and 94b with ellipsis, that can include automated computation and/or display or automated display and manual computation.

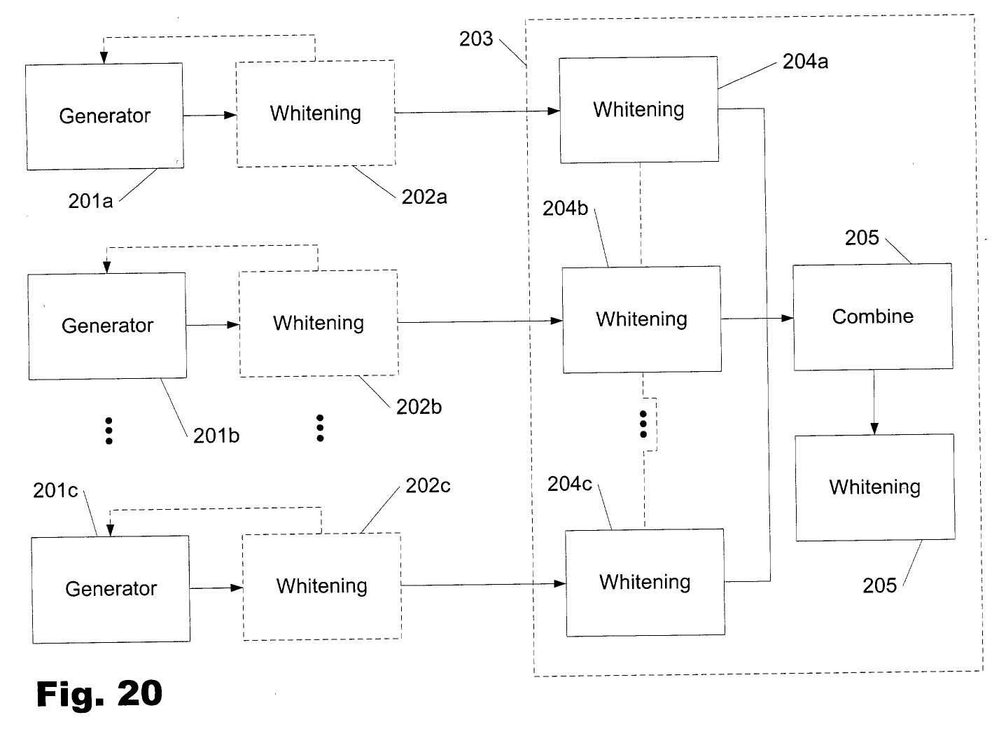

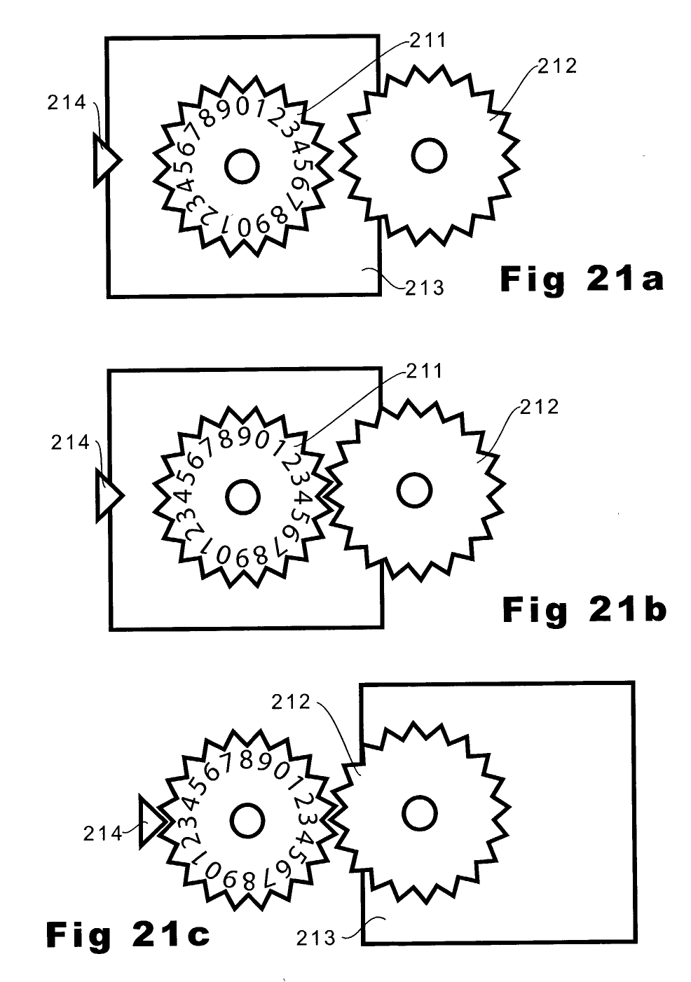

When this diagram is interpreted as a flow chart, two separate outputs of sources 91a and 91b are shown as separate steps. The dashed lines 93a indicate a second and optional output of the first sources, the first output of the first sources being indicated by the solid lines. In one example operation embodiment, first sources 91 create preferably random values and transfer commits to them over network 93 to outcome calculators 94. Then second sources 92 generate values and these are transferred over network 93 as well. Then, as indicated by dashed lines 93a, first sources open commits already mentioned by revealing additional information over network 93. Finally, the consistency of the commits and opening of them is verified by the outcome calculators 94, individually and/or cooperatively, and then the output of the second sources is combined with that of the first sources. As will be appreciated, in some embodiments, the combination of the outputs of the first sources and the second sources can be combined manually, such as can be facilitated by descriptive indicia or the like. Also, as will be appreciated, some embodiments disclosed later here do not require two rounds of communication to establish the invisible quantum values, such as those disclosed with reference to FIGS. 18 and 19, and such embodiments would not require the communication shown as dashed line 93a.

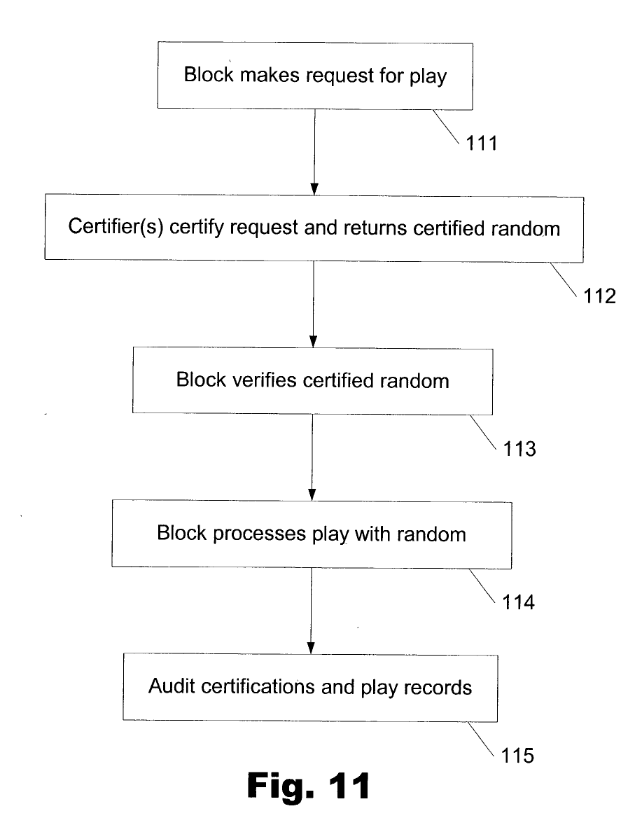

Turning now to FIG. 10, shown is a combination flow, block, and functional diagram for an exemplary embodiment of an application for gaming machines in accordance with the teachings of the present invention. Gaming machines—including as examples those that are commonly referred to as slot machines and poker machines, and also including single player or multi-player, whether or not attended by a dealer or the like, and further including linking of machines such as in progressives-generally are expected to use random numbers.

The enhanced security of random numbers offered by some aspects of the present invention can be applied as modifications of existing style system configurations or in new system configurations. In current practice, slot or poker machines may be hard-wired in groups, with individual or combined controllers and means to communicate beyond the group, such as a bridge to a radio LAN or hard-wired LAN or other network, the various details and permutations not being shown for clarity. The gaming machines of a property or multiple properties of an operator or those controlled by a particular commission or other body may be connected by communication means to a controller. A controller, where used, may learn and/or control the acceptance of money, metal tokens, paper script, electronic tokens or other electronic means of payment, and relevant payouts. In addition to a controller, a separate function of audit of records may be performed. The results of random number generators in some system are supplied by the gaming machine to the controller, such as the winning positions of wheels in a slot machine, or in other systems they may be supplied by the controller to the gaming machine.

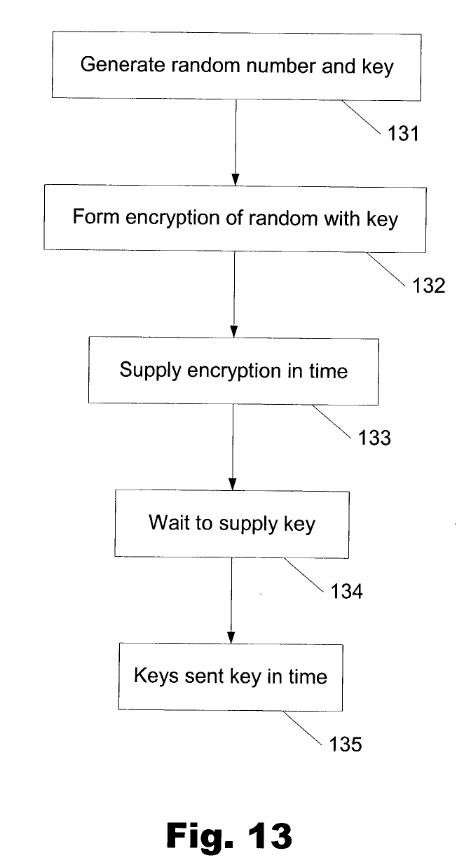

The random numbers used in gaming are in the exemplary embodiment at least controlled by one or more certifiers 101, shown as 101a and 101b with ellipsis. In one example embodiment they would realize the techniques disclosed with reference to FIG. 18 and FIG. 19. In other example embodiments, some or all of them would in effect by whatever means be providing a kind of time-stamping function to establish a sequence outside their individual ability to manipulate. In some examples some or all certifiers 101 would, possibly additionally, be providing random source functions, such as are described herein with reference to FIG. 12 through FIG. 17 and FIG. 20. And, in some examples, some or all certifiers 101 would, possibly additionally, be providing in effect an auditable record of what has occurred. Where the actual control of the gaming machines resides within the network (such as on which processor or the like) and/or how it is distributed among various points (in the sense of distributed algorithms and storage known in the art) should be considered an implementation detail, any variation of which falls within the scope of the present invention. Nevertheless, the controller 102 is shown for clarity and, as will be appreciated in recognition of legacy architectures audit function 103 is shown as attached directly to the controller. The actual gaming machines, shown as 104a with ellipsis to 104b are shown communicating through local area or wide area network cloud 105 that controller 102 is also connected to. The connection between the certifiers 101 and the controller 102 is via a network, such as the Internet, shown as network cloud 106.

In a preferred embodiment, the security-relevant protocol work is left to controller 102, which then instructs the machine and keeps the audit trails. (If the operator of controller 102 wishes further protection, they can, for instance, operate a certifier function as well.) Also preferably controller 102 would keep audit records, and/or coordinate their storage on various networks, and audit function 103 would communicate with controller 102. Of course controller 102 could simply be a bridge on a network or non-existent if gaming machines 103 run everything themselves. In either case or whatever combination, gaming machines 103 and controller 102 can, in terms of communication with audit 103 and certifiers 101, be treated as block 107.

In a preferred configuration, furthermore, a player of games would have an active device 108, such as a smart card, metal can token, card with display, PDA, cellular phone, portable computer, workstation, or whatever form factors and/or capabilities of personal information technology are realized. Such a device can provide checking of play definitions and the like on behalf of the user and/or auditing authorities. For example, it can check consistency with published and/or signed data and display parameters, indications and alerts to the user. It can also require user input directly to it from time to time. Furthermore, signatures or the like from it can be required for operation of the system. Moreover, it can provide data, over networks generally and/or as a consequence of connections with other gaming machines, that can be useful in audit.

In operation, block 107 would generate a “request for a play” that would preferably include some unique value or identifier and the definition of the wager, including such values as needed to determine the possible outcomes and associated probabilities, such as payouts. In some examples, requests for play would also include information on the funds involved, such as for example including, source of funds, whatever escrow arrangement may apply, accounts maintained in and/or outside the block, as well as potential recipients of funds and the rules for such distributions. Non-monetary values, whether script, loyalty points, complementary benefits, or whatever may be considered as another form of money for clarity of the present description.

The request for play is provided to certifiers 101, who supplies the random value back in a way linked to the request. In a preferred embodiment they would sign and return the request and the signatures could then be used to determine the random number, as will be described later with reference to FIG. 18 and FIG. 19. In other embodiments, a random number would be determined from a stream or set of such numbers that are preferably only made known after the request is issued, such generation described elsewhere as already mentioned. In either case some or all certifiers would preferably maintain records for audit and/or payout verification purposes. When active devices 108 are used, in some examples, as has been mentioned, they would interact with the user and block 107.

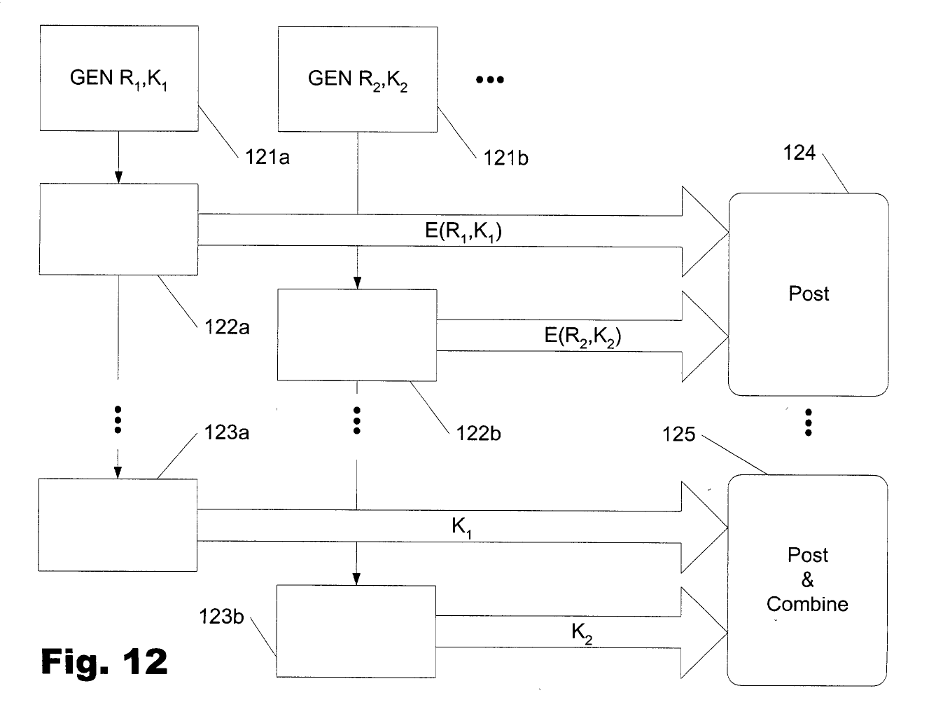

Turning to FIG. 11, shown is a combination flow and functional diagram of an application for gaming machines in accordance with the teachings of the present invention. Box 111 indicates that the block, such as block 105, comprising gaming machines and potentially related distributed communication and processing systems, makes a request for play, which as already mentioned preferably includes a definition of the way the random number will influence the play, such as outcomes and probabilities. Additional aspects of such request already mentioned include information on related payments of money, script, or whatever type of point system.

Box 112 shows that one or more of certifiers 101 process the request. One example action shown is providing certification of the request. One example way that this can be accomplished is by forming a digital signature on substantially the request and possibly including other information. The signature would then be returned to block 106 and/or posted and/or stored. The data certified can in some examples include the actual random number, in which case preferably at least a quorum of certifiers should concur that the random number was in some sense determined by the request but more specifically that it was not chosen with freedom by a single certifier and thus could be pre-arranged or manipulated by the certifier. This property can be referred to as “safe” against non-colluding certifiers. Preferably, all of a set of certifiers would have to collude to violate the safety, though some schemes sacrifice this property and only require a majority or other subsets.

In some embodiments block 107 includes a commit to a contribution to the random number, this is opened later for audit. Similar commits opened for audit (similar commits opened for audit can be used for other parameters, such as those of FIG. 18.

Box 113 is the verification by block 106 of the certification provided. In some examples the certification is digitally signed and one or more components of block 106 can each verify it using known techniques.

Box 114 is the actual play out of the game in the way and to the extent provided for by the certified random number and, in some embodiments, consummation of whatever consequent settlements are called for by the certification.

Box 115 shows a step that is included in some example embodiments where audit function 103 obtains various data from block 106, and preferably from a controller 102, and checks them for consistency including against extra-systemic data and including, in some examples, data from active devices 108.

Turning now to FIG. 12, shown is a combination flow, block, and functional diagram for an exemplary embodiment of a multiple generator technique in accordance with the teachings of the present invention. Box 121a and 121b are random number generator parties, and they are shown with an ellipsis to indicate that any number of such parties can participate. In a first stage they each generate what can be thought of as two values: a random number contribution R and a key K. These are shown for clarity with traditional Arabic numeral subscripts corresponding to the party. Various ways to create and whiten numbers are mentioned elsewhere here and they may be applied to generate keys, though the requirements can differ to some extent, as is known in the art. Thus, in the example shown, 121a shows the generation of random value R₁ and key K₁, and 121b generates R₂ and K₂.

In a second stage, each party is to supply what is shown as an application of an operation E to the pair of values created by the party in the first stage. What is believed desired is that the mapping (at least with high probability) determines R uniquely and at the same time, the best known way to recover R would be to exhaustively search through potential values of K. As one example of an appropriate function, a conventional encryption technique, well known in the art, can be used. Since K would be chosen preferably from a relatively small interval compared to those that keys for such encryption are generally taken from, a mapping from the smaller interval to the larger would be made. Such an “expansion” mapping would preferably be cryptographic in nature so as to reduce the concern about how the encryption algorithm would behave for particular keys. It might be taken, for example, as the encryption or hash of K under some other scheme. To prevent pre-computing and otherwise preparing to make a fast exhaustive search, the known technique of “salt” values can for example be used. Each salt would be preferably unique to the participant and only announced/determined just before or with the use. One example way to incorporate the salt would be in the expansion algorithm, where it could enter as a key. As another example, it could enter as all or part of the data to ultimately be encrypted. This last would give the encryption a kind of redundancy check on a K. Such redundancy, whether with constant, salt, or other structure, as is well known, would in some examples provide it is believed the unique determination of R at least with high-probability. Thus, in the example shown, 121a sends E applied to R₁ and key K₁, and 121b sends E applied to R₂ and K₂.

Also in Stage 2, the messages sent over the communication means shown are posted by parties shown as post 124. Such a party can in one example be one or more trusted or partly-trusted parties and/or m other examples be a public network, such as the Internet. The set of values posted is preferably agreed on. For instance, the set of parties can be known and fixed and each message can bear the agreed unique digital signature of the party sending it. In other examples, the set of messages are for instance determined in another agreed manner, such as by a deadline or other decision rules, procedures, bodies, or whatever.

Once committed in this way, in order to generate the random number, the encryptions are opened, preferably by making public the values K of the example. Once these values are public the agreed set of messages can each be decrypted with its respective key and the values of R determined by decryption with the respective K's. If for some reason one or more parties do not supply K in time, preferably the other parties and/or others exhaustively search for the missing values K. Cryptographic schemes generally with such small keys that are intended to be searched for in some cases are believed to have been first introduced by Merkel, who referred to them as puzzles. If some collusion of parties can solve the puzzles of the parties not in their collusion before the deadline, they could determine the combined random value early. But, the scheme does not allow them to use this knowledge for instance to decide that they don't like that particular random value and stop it from being used, because even if they withdraw their cooperation, the value can still be computed by solving the puzzles. Also, they could try to use the early knowledge to advantage in play of the game or whatever. This possibility can be reduced to an acceptable level by adjusting the size of the time window during which the commits are posted and the interval after that during which the random value is assumed unknown. Such a pair of intervals are believed acceptable if their combined length is considered too short to give anyone a non-negligible probability of solving a puzzle. Thus, in the example shown, 123a and 123b send K₁, and K₂, respectively, to post and combine 125, that then decrypts and adds the two R's in the appropriate group as described elsewhere.

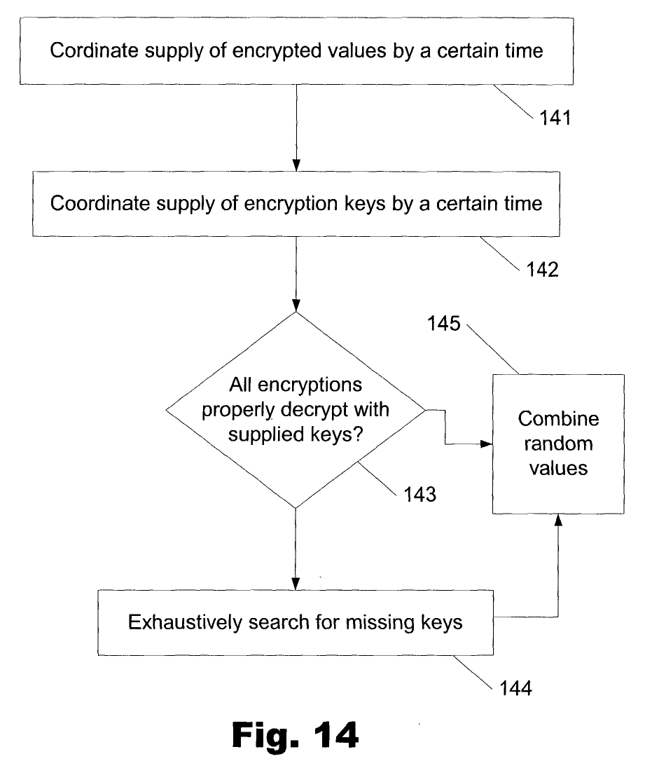

Turning to FIG. 13, a combination flow and functional diagram of an exemplary embodiment of a single generator within a multiple generator technique in accordance with the teachings of the present invention will be described. In a first step 131 a supplier party generates a random number and a secret key. In a next step 132, the supplier party in effect forms a puzzle of the random number using the key. In one example, already mentioned, the puzzle is formed as an encryption with a cryptographically expanded and salted form of the key. Box 133 indicates that the puzzles are to be supplied within particular time constraints. Next is shown box 134 that holds the key since it is not to be supplied for a certain period. Then, as box 135 shows, the key is supplied within the period that it should be.

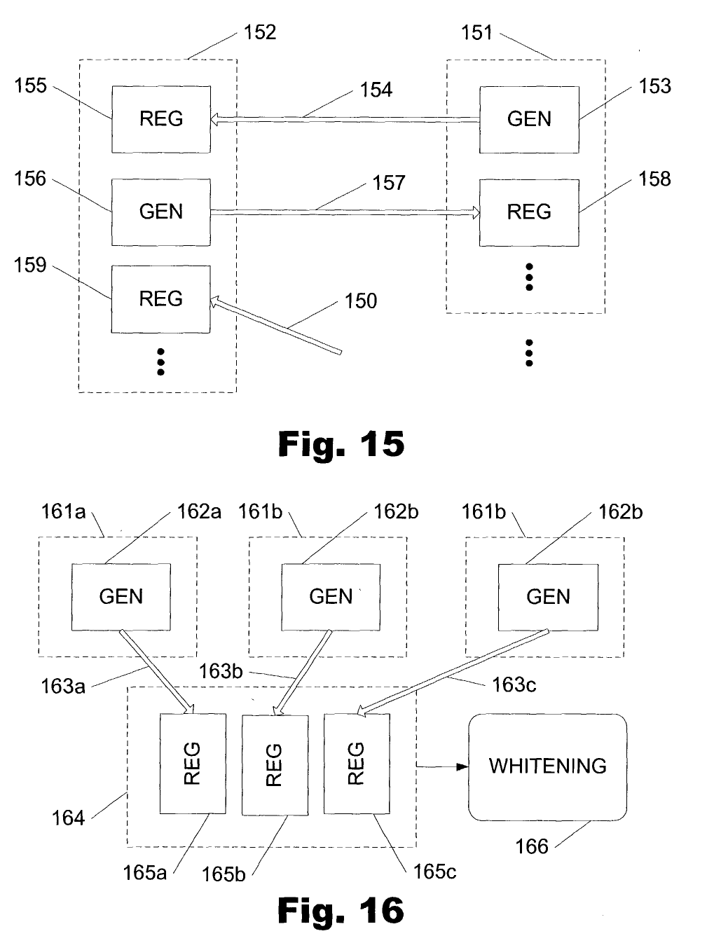

Turning now to FIG. 14, described is a combination flow and functional diagram of an exemplary embodiment of a multiple generator technique in accordance with the teachings of the present invention. For instance, in a batch oriented system of the type presented with reference to FIG. 12 and FIG. 13, a particular time interval would be determined during which the values should be posted; a following time interval would be known (preferably with a buffer zone between the two to allow for inaccuracy of clocks) during which the random numbers could be considered safe. Preferably within a certain non-overlapping and later time window, but by a certain deadline. The figure refers to certain cut-off times appropriate from a central coordination point of view (though in some systems the deadline can be defined more dynamically, such as when enough submissions are in), while the beginning of the windows is a point before which the sender should be careful not to reveal the value.

In particular, box 141 calls for obtaining the random values and keys by a certain moment. Similarly, box 142 is cooperation aimed at obtaining the keys by a certain time. Box 143 determines if there are some keys still missing at the certain time of the previous box. If not, box 144 calls for exhaustive search to find the missing keys. As is known in the art, such search can be run in parallel by different searchers covering hopefully different parts of the search space, and various techniques for coordinating such a search are well known. If no key that properly decrypts can be found, then that particular contribution is deleted. Finally, box 145 is where the random contributions from the commits that properly decrypt are combined, such as by a group operation or other method as already described; the combining might, in some examples, be done by actual users of the result based on signatures on the other quantities.

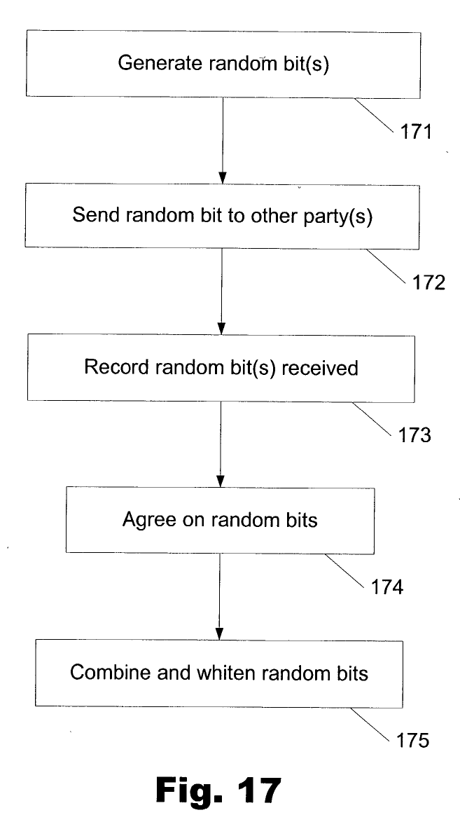

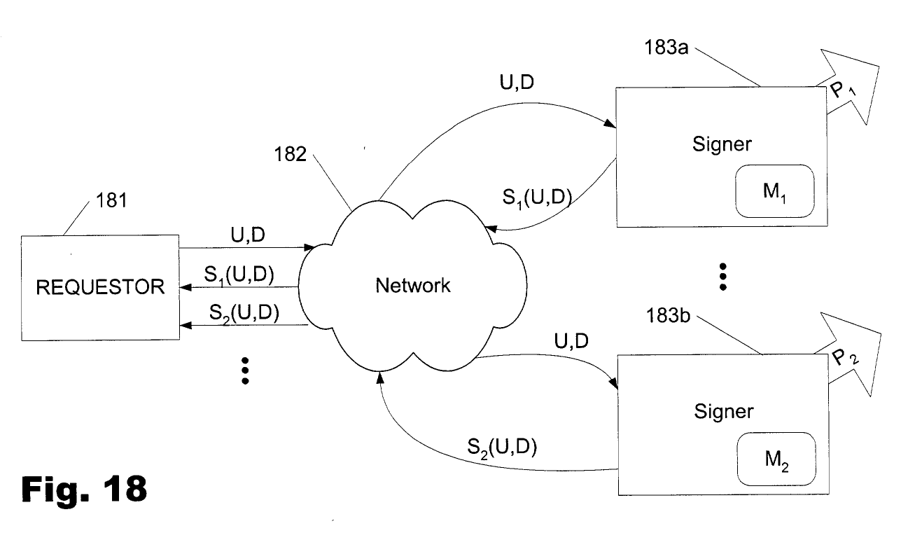

FIG. 15 and FIG. 16 show combination flow, block, and functional diagram for two configurations of on an exemplary embodiment of time-based random number generation in accordance with the teachings of the present invention. Two node sites 151 and 152 are shown, each intended to be at a particular location, and the possibility of many more locations, each of whatever configuration, is also indicated by ellipsis. Site 151 contains a generator 153 that is configured to send random bits in the example over preferably dedicated and minimal delay link 154 to registers 155 at site 152 already mentioned. A generator is a random number generator, preferably fast and/or regular enough to generate bits within the required windows without holding bits and receiver registers are preferably devices for clocking bits into a storage medium, such as shift registers that are clocked by a local timing source adjusted to conform to one shared by other participants. Similarly, generator 156 sends over line 157 to register 158. As an example of other pairs not shown, register 159 receives over link 150 from generator not shown. More generally, it is believed that arbitrary networks or graphs of such sites can be used. Each connected graph can yield a random number that is combined and preferably whitened later, as will be described with reference to FIG. 16 for a centralized system. In a more distributed model, an illustrative example is that parties can issue digital signatures on the bits that they have created and also on what they have received at particular coordinated times. If the signatures are consistent, that is what parties say they sent on particular wires is what parties say they received on those wires, then the result is valid and can be combined; otherwise, there is a dispute to resolve by some appropriate method, such as removing the offending link(s) from the graph.

Referring now to FIG. 16, a star type configuration of the system already described with reference to FIG. 15 is illustrated. In particular, parties 161a, 161b, and 161c each have their own generators 162a, 162b, and 162c, that transmits over link 163a, 163b, and 163c, respectively. The party at the center of the star 164 has receivers 163a, 163b, and 163c configured to receive over links 165a, 165b, and 165c, respectively. Also shown here is that the output can be whitened 166 after being combined. As will be appreciated, better security is believed obtained by parties transmitting the random bits as soon as they can, such as directly from the underlying generator. Verification of the bits by the transmitting parties can, for example, in some embodiments be by authenticated message from the transmitting parties and/or no objection to an authenticated message from the receiving party. It is believed, however, that the central site could, in collusion with one of the remote sites, manipulate the outcome by manipulating the contribution of the remote site. If a central site is highly-secured and/or verifiable by the other participants, this may not be an issue, such as in a single-room facility with inspected and/or redundant and/or randomly-chosen hardware. The combination could be simply exclusive-or. Whitening operations, such as removing bias and so forth that would normally be done after generation are preferably done after combination in such systems so that the secret bits don't have to be kept around at the generators for a length of time that would allow someone to get a copy of them in time to cheat.

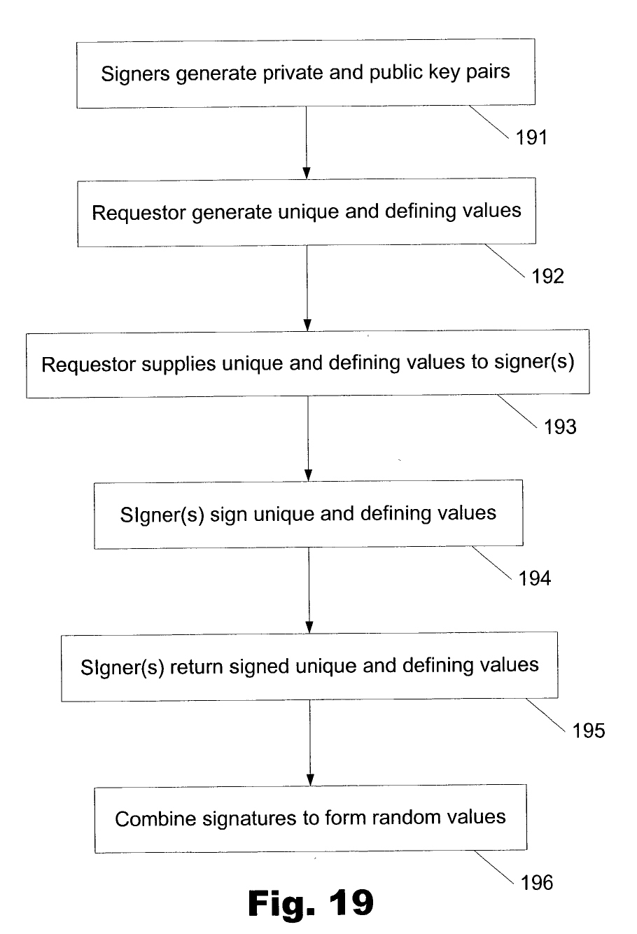

Turning to FIG. 17, presented is a combination flow and functional diagram of an exemplary embodiment of time-based random number generation in accordance with the teachings of the present invention. Some examples of this sort of system is illustrated in FIG. 15 and FIG. 16. A first step 171 comprises each party generating one or more random bits. A second step 172 is preferably, as already mentioned, without delay but at suitably accurately timed instants sending generated bits to other parties. Box 173 shows parties receiving such bits sent in box 172 and retaining a record of those bits. Box 174 is the agreement on the random bits by the parties. In cryptographic authentication of messages allows the parties to exchange the values and agreements on them or to not send objections, some examples of which have already been mentioned with reference to FIG. 15 and FIG. 17; this gives the parties a way to be sure that their contributions are correctly counted; it also allows the parties to form the combination and/or do whatever whitening, as indicated in box 175.

Turning now to FIG. 18, shown is a combination flow, block, functional and schematic diagram for an exemplary embodiment of a signature-based random number generator system in accordance with the teachings of the present invention. A requestor of a random number sends a request, shown as comprised of a U and D part, over a network. It is preferred that there be a unique label associated with the transaction, in some applications, such as gaming, preferably verifiably consecutive, such as a serial number concatenated with a unique machine identifier. An encrypted form of the serial number can also be suitable. The value U can, as another example, be chosen at random from a large space, particularly when blinding is being applied and when it does not help the party choosing it to have it collide with the choice of another party. The value D, optional in some example embodiments, is definitional information related to the situation of use for the requested number. As one example, D identifies the game rules among a set of known game rules, the payout rules among a set of known payout rules, and any current configuration of the state of play that is relevant to these; thus, once the random value is known, the amount of payout, if any, and the change in the state of play, if any, would be determined and readily calculated.

Signers 183a and 183b are shown, and the participation of more is indicated by ellipsis. Each signer has at least one published or otherwise distributed public key, shown as leaving the respective signer in an arrow, as P₁ for signer 183a and P₂ for signer 183b. Each signer is also shown as having data storage M₁ and M₂, respectively. As an example of what can be stored there, consider the corresponding private key. Another example is the set of signatures issued, for such purposes as audit or enforcement of payout. When a signer receives a request, preferably comprising the information content of the pair of values U and D, the signer, in some exemplary embodiments, forms a digital signature determined by them. For instance, the signer first applies a hash function or the like and then forms a digital signature with a substantially bijective signing function, such as are well known in the art. The signature by 831a is shown as S₁(U, D) and 831b is shown as S₂(U, D). These are returned to the requestor 181 over network 182 as shown. A variation not shown for clarity is one type of signature scheme that gives the same signature from any subset of parties, thereby reducing the requirement that responses be received from all of them.

An alternate embodiment, not shown for clarity, is where the requestor commits to a contribution and sends this to one or more parties; whatever they send back is then combined to form R. One problem with this is a single last party can cheat the outcome in collusion with the requestor. A two-phase protocol that overcomes this comprises, for example, commits by all the parties that are provided in a first phase and an opening of all the commits as a second phase. This can be twice as slow and does not prevent, in and of itself, collusion of all the parties from manipulating, although such a collusion is believed to know in advance. The techniques described with reference to FIGS. 15-17 are applicable.

Turning now to FIG. 19, presented is a combination flow and functional diagram of an exemplary embodiment of a signature-based random number generator system in accordance with the teachings of the present invention. Box 191 shows signers generating their private keys and posting their public keys. Plural pairs per signer with preferably disjoint validity intervals/requirements would allow for transitions. Requestors determine preferably unique transactions including defining parameters as shown in message 192. Then, in box 193, requestors provide the request data to the one or more signers. The signer or signers form digital signature or the like preferably as a function of information contained in the request as indicated by box 194. Then the signer(s) return as indicated in box 195 the result of the signature process preferably at least to the requestor. Finally, as shown in box 196, the random value can be formed as a function of the signatures.

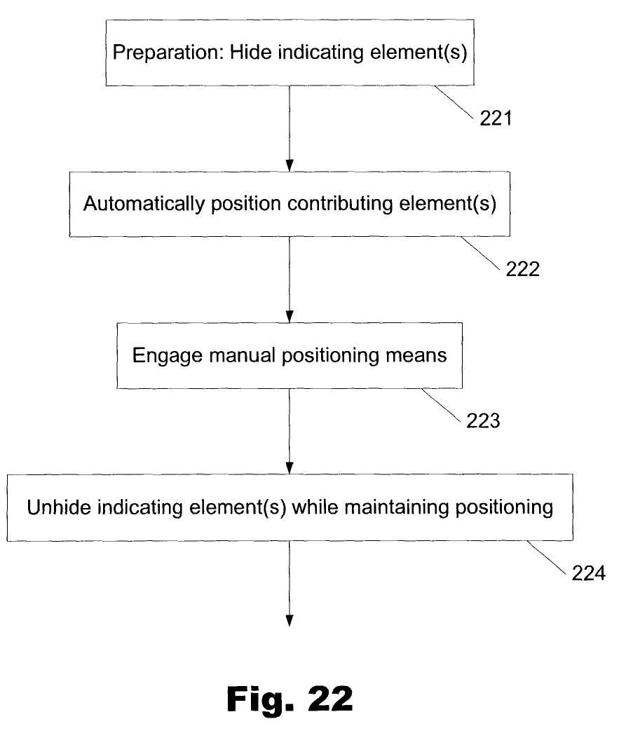

Turning to FIG. 20, combination flow, block, functional and schematic diagram for an exemplary embodiment of whitening in random number generation in accordance with the teachings of the present invention are shown. Various generators and combining configurations are depicted to illustrate some exemplary ways that whitening can be introduced into a system. Generators 201a through 201c, shown with an ellipsis, are the raw source of randomness, preferably based on quantum noise. Each can be whitened by corresponding whitener 202a through 202c, shown with an ellipsis. One kind of whitening is to remove simple statistical properties, such as bias assuming bits are independent of each other, the example mentioned elsewhere. Other types introduce cryptographic complexity, to make an adversary's work difficult if they try to exploit some flaw in the underlying generator.

This first stage of whitening 202 is shown as optional by the dashed lines because some embodiments prefer speed over statistical properties at this stage, such as has been mentioned with respect to FIGS. 15 through 17. Also shown is feedback from the 202 devices to the 201 devices. This is intended to indicate possible arrangements where state is maintained and it influences new values in the way that they are physically generated and/or in the way that they are algorithmically whitened. Thus, for example, a hash of any old state and new bits can become the new value of the state.

The concentrator 203 takes one or more inputs, typically from other parties or isolated devices and combines them. Various kinds of whitening, 204a through 204c, can be applied at the front end as the values arrive, such as mapping by a one-to-one one-way function or statistical whitening. Also shown in dashed lines are optional interconnection between these whitening stages that allow one to influence others. At some point the whitened inputs are combined 205, as described elsewhere. Finally, the output of the combined sources can itself be whitened. Cryptographic transformations, such as invertible, one-way, compressing, or bijective can be applied to advantage, depending on the requirements, to thwart various potential avenues of attack against a system with or without collusion and with or without failures.

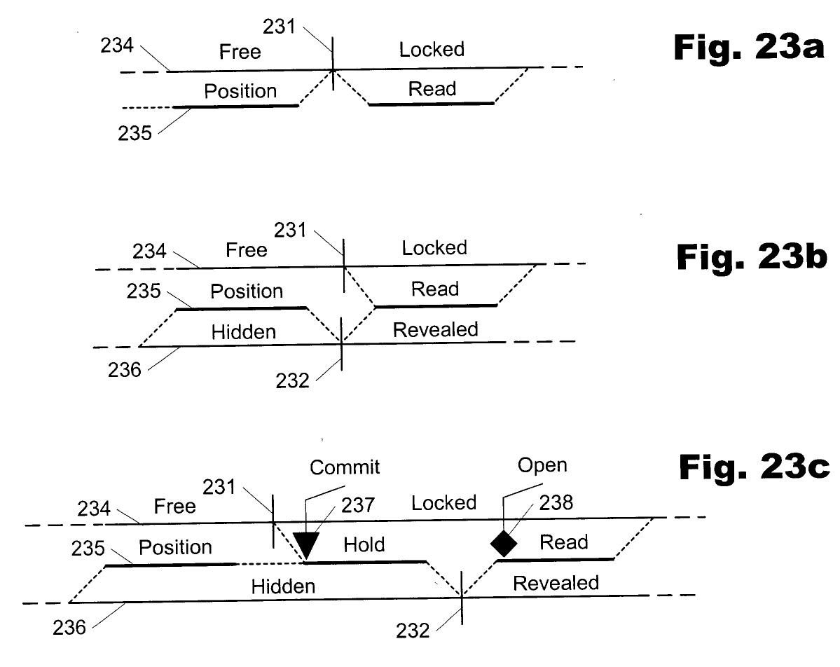

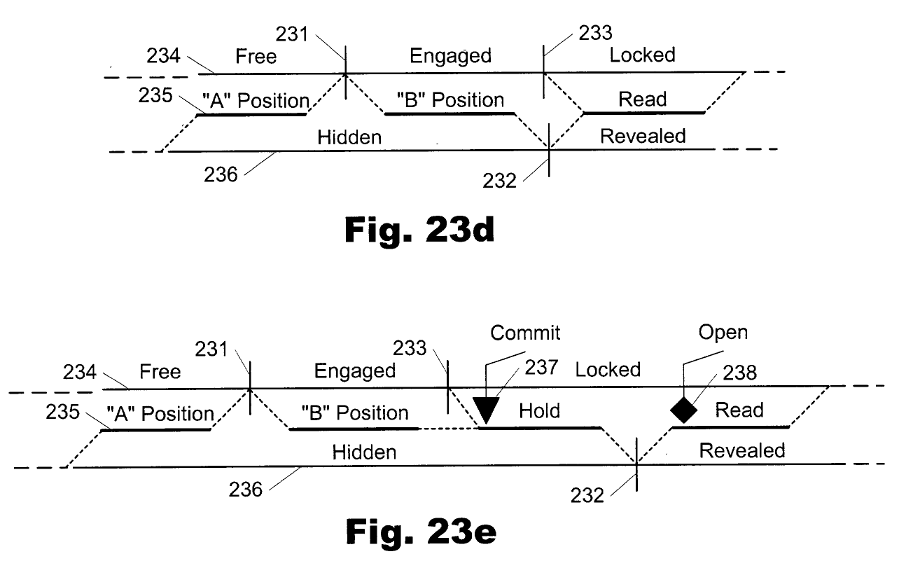

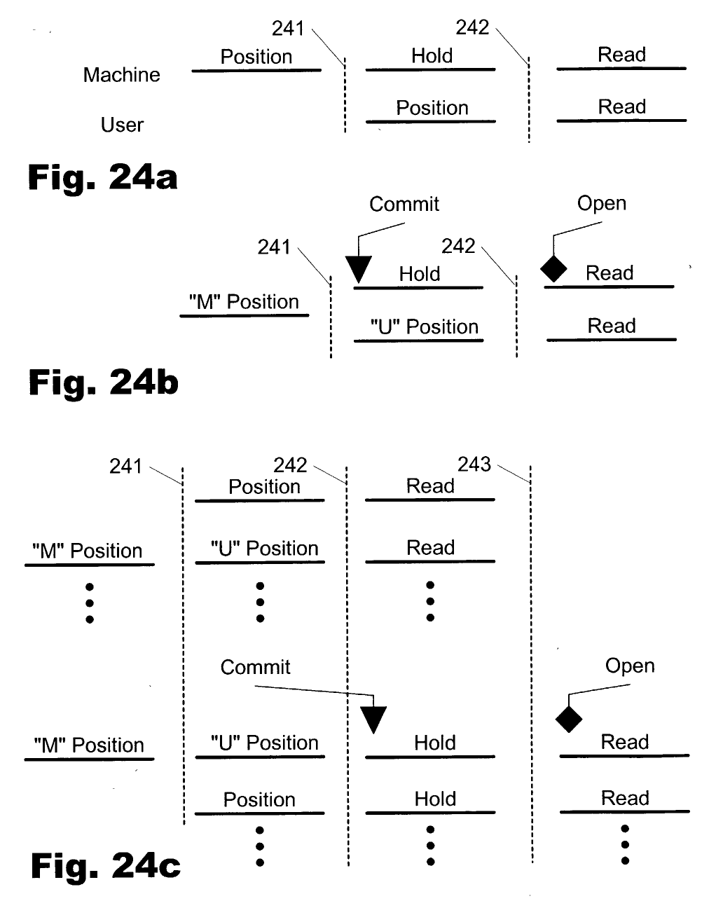

Turning now to FIG. 21a through 21c, shown in different states, combination schematic, functional and plan view diagrams is an exemplary embodiment of a device for mechanically generating random or other numbers in accordance with the teachings of the present invention. In particular, FIG. 21a shows a device in a first state, FIG. 21b shows it in a second state, and FIG. 21c shows it in a third state. The three states correspond to the three states as will be described with reference to FIG. 23d and the last three boxes of FIG. 22. The lower of the rows is for the manual or mechanical generator.

Referring now particularly to FIG. 21a, a hideable element 211 is shown, in the example, as a mechanical member that bearing indicia and able to be rotated around an axis. A user operable member 212 is shown, in the example, as a similarly rotatable member. A hiding shutter 213 is shown, in the example, and in this state, is intended to hide the position of hideable member 211, or at least a portion of it to make the indicated value hard for an observer to determine. In the view shown for clarity, as will be appreciated, the shutter 213 is shown behind the other elements, such as if the indicia on hideable member 211 were visible from both sides or visible through a mirror. Additionally, in the example, a locking element 214 is shown unengaged with hideable element 211; similarly, operable member 212 is not engaged with hideable element 211.

Referring to FIG. 21b, hideable element 211 is shown engaged with user operable member 212, thereby coupling their ability to rotate relative to each other, so that it can cause hideable member 211 to be changed in position, such as, for example, by being rotated. Hiding shutter 213 is shown, as an example, also as in FIG. 21a, in the same obscuring position. Locking element 214 is shown still unengaged with hideable member 211.

Referring finally to FIG. 21c, hideable element 211 is shown still engaged with user operable-member 212, although this is believed superfluous at least in some examples. Hiding shutter 213 is shown now in a configuration that allows the resulting values to be read by a user and also, in this example, that exposes the locking element 214 and its operation as well as the intermeshing as already mentioned, all as examples of allowing user observation to increase confidence in the properties enforced by the mechanism. Locking element 214 is shown substantially locking relevant motion of hideable member 211.

In operation, the states shown in FIG. 21 are in normal sequential order of use. First the configuration of FIG. 21a allows the hideable element to be positioned under automated control, such as by a stepper motor not shown for clarity and for whatever positioning means to be responsive to whatever generators of random or other values, whether local and/or remote to the device that the user interacts with.

Means not shown for clarity then, as illustrated in the example of FIG. 21b, allow transition to a configuration in which the hideable element 211 is still substantially obscured but engaged with user operable member 213, preferably in a manner that leave the relative positions unchanged from that last imparted to element 211. The locking element 214 does not inhibit the movement of the hideable member in this state. Thus, in this arrangement the user can change the position of the operable member 212 and thereby cause the cooperating hideable element 211 to change its orientation and the resulting value. In some examples, indicia or other ways for the user to know the change they have caused are preferably provided; while in other examples, such provisions can be absent and means can be used to make such knowledge/control by the user difficult, such as, for example, slipping clutches, free-wheeling states, or the like.

Finally, the state shown in FIG. 21c is brought in. The means for accomplishing this are not shown for clarity, but examples include allowing the user to slide the elements into this configuration without disengaging, or as another example, solenoid operated mechanisms. The locking element 214, in this state, prevents the movement of hideable member. The shutter 213 has been moved to expose the hideable member. The resulting value can, as an example, be taken to be the that indicated in a position on the hideable member, such as the value three indicated by locking element 214.

Turning now to FIG. 22, described is a combination flow and functional diagram of an exemplary embodiment of a machine and user operable element in accordance with the teachings of the present invention. One example of such systems has just been presented with reference to FIG. 21. The present chart shows the preparation and operational states of such a process.

In particular, box 221 calls for first hiding element(s) that would be sufficient to substantially conceal the value to be arrived at by concealing various elements, parts of elements, and/or aspects of elements. Then box 222 allows elements contributing to the resulting value to be arranged and/or configured and/or positioned so as to make or influence the contribution of these elements. Next, box 223 provides for the engagement or cooperation of manually operable means and the not necessarily separate contributing elements already mentioned, so as to allow the former to influence the contribution of the contributing elements. Finally, box 224 is the unhiding of the elements representing the resulting value while holding that value substantially constant so that it can be read.

Turning now to FIG. 23a through 23e shown are combination flow, block, functional and schematic diagrams for exemplary embodiments of elementary random-number deriving systems in accordance with the teachings of the present invention. The first, FIG. 23a, is the simplest of the set, being a unilateral value display. The second, FIG. 23b, extends this to include hidden followed by revealed states. FIG. 23c extends further to include a hold state intermediate to the previously introduced two states, as well as cooperation through cryptographic commitments. Then FIG. 23d includes techniques related to those already introduced with reference to FIGS. 21 and 22. Finally, FIG. 23e extends its predecessor much as FIG. 23c extended FIG. 23b. The notation used indicates temporal relationships through lines moving from left to right and vertical bars symbolizing transitions on lines that indicate states. The thickest lines are the actual operational intervals of the mechanisms or processes.

Referring now particularly first to FIG. 23a, the transition 231 demarks a change from the “Free” state to the “Locked” state of the state element denoted as line 234. The operational intervals are on line 235, the first denoted “Position” and the second “Read”. As will be appreciated, the diagonal dashed lines leading from the Position interval to transition 231 are intended to suggest that the Position interval preferably be made to occur at a time that precedes or is at latest at the same instant as transition 231; similarly, and also by way of defining the notation used elsewhere in this figure, the diagonal from transition 231 to the “Read” interval is meant to indicate that the read interval should commence temporally simultaneously or generally after transition 231. Thus, as will be appreciated, what is shown is, at least in one embodiment, a mechanism that allows an indicator to be set up until a certain moment and then provides for it to remain indicating the same value and be read by users, for example, during a subsequent interval. Concretely, as an illustrative example only, the position of a chip on a felt playing table can be thought of as a simple illustration of this concept, as once placed and the hand removed, it is easily seen to remain in position during a certain interval. This is an atomic element of some exemplary embodiments of the notion of a commit as used elsewhere here.

Referring to FIG. 23b, the transition 231 again demarks a change from the “Free” state to the “Locked” state of the state element denoted as line 234. The operational intervals are on line 235, the first denoted “Position” and the second “Read”. Line 236 reflects the state of hiding or revealing of the position, the transition between the two being denoted by bar 232. Thus, it is preferable that the positioning take place only after the hiding is provided, as indicated by the dashed ramp up to the “Position” interval. Similarly, positioning is preferably finished before the value is revealed, as indicated by the following ramp down to bar 232. The temporal relationship between the “Read” interval and the transition to revealed 232, is indicated by the ramp up. Preferred relations between the “Read” interval and the “Free”/“Locked” transition are shown by the ramp down; the following ramp up shows that the reading is preferably not provided past the end of the locked state. Concretely, as an illustrative example only, the position of dice shaken but kept under a cup remain in position and hidden during an interval and are then revealed and remain in position when the cup is carefully removed.

Referring to FIG. 23c, in addition to the extensions of FIG. 23b, the transition 231 and 232 are separated in time to make an intermediate operational interval between two. The “Hold” interval is shown after transition 231 and before transition 232; during hold, the value remains hidden and fixed. Also shown are two cryptographic operations: “Commit” and “Open”, as are known for so called “bit commitments”. The “Commit” is issued 237 preferably near the beginning of the hold interval, but potentially elsewhere before the “Open” 238 is issued. Preferably, the value determined by the Position and exposed during Read is at least included in the value committed to and opended.

Referring to FIG. 23d, in an elaboration of the embodiment of FIG. 23c, the transition 233 is added, defining an “Engaged” interval between it and the preceding transition 231. During this Engaged interval a second positioning, “B” Positioning, can be accomplished. The first positioning can be the automated one and the second the manual one, for example in the embodiments described with reference to FIG. 21 and FIG. 22. The second positioning is shown preferably after transition 231, to separate it from the first positioning, and before transition 232, after which the value can be revealed. If the same indicator mechanism is changed by both, then the effect is believed to be that no one of them alone can choose the output.

Referring finally to FIG. 23e, as an extension to the embodiment of FIG. 23d, the transitions 233 and 232 are separated in time to make between the two an intermediate operational interval labeled “Hold”. As also in FIG. 23c, such extension allows the cryptographic primitives Commit and Open to be included. Here the two separate positioning intervals are included along with the Hold interval. This is the most inclusive and elaborated example version presented in this FIG. 23.

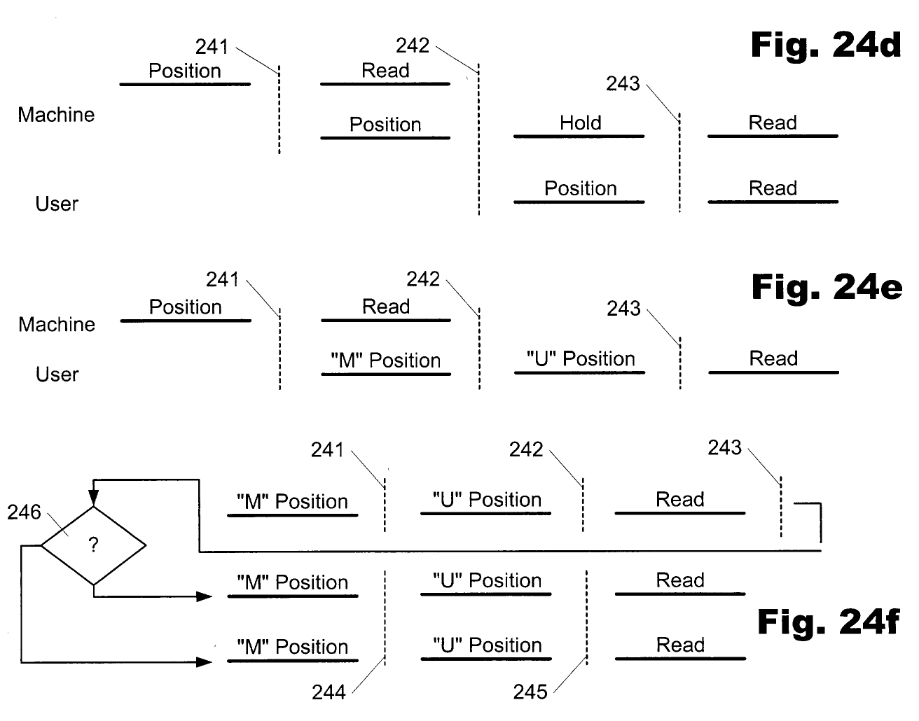

Turning now to FIG. 24a through 24f shown are combination flow, block, functional and schematic diagrams for exemplary embodiments of random number deriving application systems in accordance with the teachings of the present invention. The first, FIG. 24a, is an example related to those described already in FIG. 3 through FIG. 8. The second, FIG. 24b, extends this to include an example single-user system related to a combination of those of FIG. 23c in combination with those of 23d. FIG. 24c is an characterization of an example set of multiple user and multiple location applications. Then FIG. 23d and 23e include example techniques related to those already introduced with reference to FIG. 24a and 23d, respectively, with additional pre-displayed values that it is believed can enhance user appreciation of system operation. Finally, FIG. 24f, using the paradigm of FIG. 23d as an example, illustrates systems where the choice of experiments depends at least in part on the outcome of other experiments. The notation used indicates temporal relationships through operation interval lines (as ready described with reference to FIG. 23) moving from left to right and broken vertical lines representing temporal boundaries.

With reference now particularly to FIG. 24a, two actors are shown, each on their own horizontal line, one labeled as “Machine” and the other as “User”, representing the apparatus and supporting system and one or more human users, respectively, as generally also elsewhere here. As in the other parts of this figure, the temporal boundary line 241 divides the intervals in the earlier occurring column on its left from those of the later occurring column on its right; similarly, division line 242 separates the rightmost two columns from each other. Thus, in operation, during a first phase, the machine positions an element, such as by stepper motor or otherwise, whether controlled or not. Then, passing the temporal border of line 241, the two intervals occur in parallel and potentially at least simultaneously. The upper of these intervals is holding of the result of the first mentioned positioning. The lower is the positioning by the user of element(s). After the third time zone is entered by crossing line 242, the positions of all the elements are made available for reading in a locked state so that the value can be determined by an observer.

Turning now to FIG. 24b, two related operational interval lines are shown with a common component. The upper is an example instance related to that system described with reference to FIG. 23c and the lower to that of FIG. 23d. As will be appreciated, the “M” positioning serves both the role of the “Positioning” of 23c and the “A” positioning of FIG. 23d. This example application can for instance be operated by a single user with the benefit of commit and open techniques to provide further assurance that the values of the first positioning were not changed. The sharing of positioning operations or the incorporation of the results of multiple such operations into single subsequent operations is more generally implied as an example elsewhere here where appropriate. The two operations of FIG. 23d, denoted there as “A” and “B” positioning, are shown as instantiated here as a “M” or machine positioning followed by a “U” or user positioning, as elsewhere here in this FIG. 24.

Turning now to FIG. 24c, a novel elaborated multi-user and multi-site example is presented in accordance with the invention. As will be appreciated, there are two groupings of operation intervals, an upper and a lower, each with their own ellipsis. Thus there may be any number of instances of members of each of the groupings. Moreover, the members of the groupings, for clarity, are only illustrated by limited suggestive examples. For instance, the type of hybrid presented with reference to FIG. 24b, or its further elaboration and/or generalization, can be included within either. Similarly, as another example, variations such as those to be presented with reference to FIG. 24d or 24e can also be combined. The Commit and Open cryptographic enhancements can be applied to substantially all of the components of the lower grouping, as is intended to be suggested in the illustration by their spacing away from the particular operation interval instances.

An example inventive rule for the operation of a multi-site application can be that the cryptographic operation takes precedence over the corresponding physical reading, in case they are in disagreement, which of course should not happen if all parties are perform correctly. Accordingly, before the transition of line 243 is crossed, all parties should preferably agree on all the Commit values and also on all the Read values from the upper collection. Thus, as an example benefit of such a configuration, even if a collusion were able to compromise the integrity and control the outcome of the upper collection and the read values of the lower collection (but not learn the values Committed to before the crossing of line 243), it is believed that they would be unable to control the outcome of the whole process. And at the same time, as another example, confidence in the physical operations it is believed should also be sufficient for confidence in the outcome, independent of the automated mechanism (assuming that the Opended values and those Read in the fourth phase are in agreement as they should be).

With reference here to FIG. 24d and 24e, example embodiments with early display of values for user benefit is shown. In particular, the value read between lines 241 and 242, which is to be combined with the later read values in determining the outcome, is made known at this stage. The benefits are believed from a purely security perspective to be negligible, but the user experience is enhance by a kind of “shuffle of the deck” that will influence the play. As will be seen in FIG. 24d, the second and third row together constitute an instance of the techniques of 24a, already described. Similarly, for FIG. 24e, the second row can be interpreted as an instance of the already described techniques of FIG. 24d.

Finally with reference particularly to FIG. 24f, three example instances of techniques like those of FIG. 23d (being chosen for compactness though any of the already described techniques can be used) are combined in an exemplary novel way. The outcome of the first instance, resulting from the operation interval just before line 243, is used to determine, by way of a decision function 246, between in the example two instances, an upper and a lower, which are internally both separated by lines 244 and 245. As will be appreciated, some of the instances may in fact share mechanism, such as in the case of a “draw” or other outcome that requires a repeat. Also, as will be appreciated any number of options may be selected by a choice function in general and some or all of them may have choice functions themselves. Moreover, choice functions can depend, for example, for their result on which other instances have occurred, any number of values resulting from other instances, and also on other values.

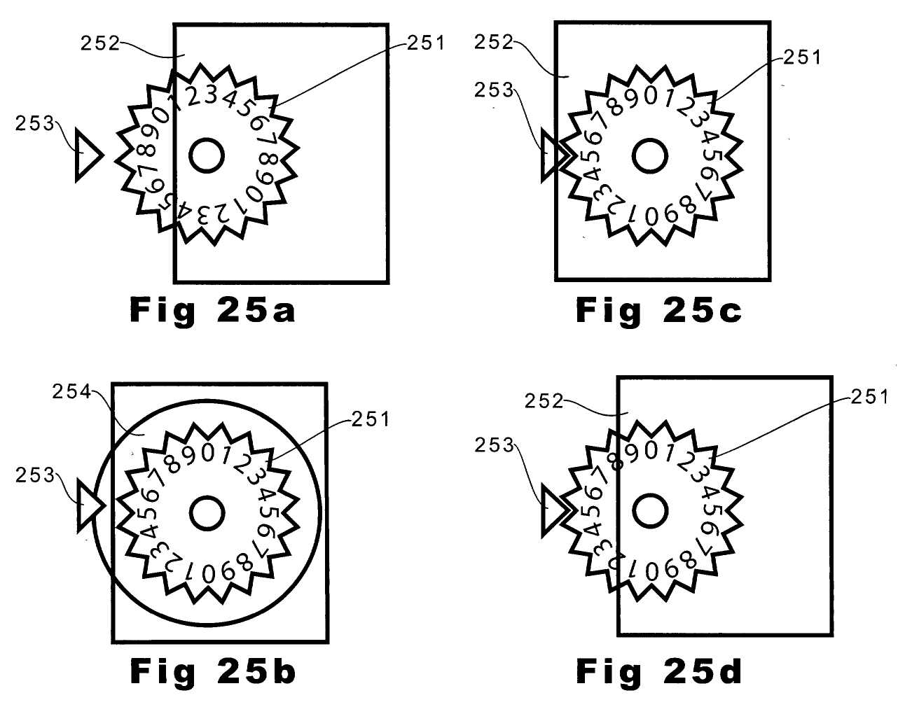

Turning now to FIG. 25a through 25d, shown are combination, block, functional, schematic, plan view diagrams for exemplary embodiments of a visible motion quantum generator display and locking system in accordance with the teachings of the present invention. FIG. 25a shows an example spinning state; 25b a hidden state; 25c a locked and hidden state; and 25d a locked but revealed state. One believed advantage of the configuration shown is that it allows the user the excitement of seeing the movement, if only for a part of the time.

In some embodiments, parts of the wheel not bearing identifying indicia can still be seen spinning while the indicia are hidden. In yet other variations a faux moving part that is uncoupled to the indicia bearing part and does not reveal the stopping point of the actual indicia is allowed to come to a complete stop in view of the user. In yet another variation, the actual indicia-bearing element is allowed to come to a stop in full view, but the value it lands on is determined by an arrangement that was fixed before it began moving—one way to accomplish this being an indicating element that is coupled with the rotational element only after the rotational element has been given an initial secret spin/displacement and that can spin with the rotational element but that ultimately is revealed when the device stops and can readily be seen as indicating the actual stopping configuration as predetermined. The indicating element can in some embodiments serve as a kind of translation or mapping from, for instance the symbology of a cooperating mechanical generator as have been described. All of these variations are shown as the disc 254, which appears for clarity only in FIG. 25b and without showing its coupling. It may include stripes or other indicia to allow its spin to be readily appreciated by viewers.

In particular, rotationally mounted member 251 exposes its indicia since hiding screen 252 does not cover them from view of a user. And locking element 253 is not engaging the cooperating structure of rotational member 251. In some example embodiments, not shown for clarity, rotational member 251 is spun by stepper motors or the like influenced by quantum engine also not shown. One example configuration is of a traditional slot machine wheel; another example is a kind of “wheel of fortune” themed device.

Preferably while still spinning with unpredictable stopping point, hiding screen 252 is brought to a configuration that obscures preferably all of rotational element 251, as depicted in FIG. 25b. Also in this configuration rotational element 251 is shown having stopped rotating and being positioned so as to indicate the result of the quantum generator. Further shown, as already described, is disc 254 that is preferably coupled only part of the time to rotational element 251, but visibly so in some states, such as that to FIG. 25d to be described.

While in the rest state preferably locking element 253 is brought into engagement with rotational element 251 or interconnected parts not shown so as to hold it from rotating to a position at least accurately enough that different indicia is not indicated. As will be appreciated, the change in configuration of locking element 253 is preferably but optionally visible as it is not blocked from user view by screen 252.

Finally, screen 252 is move away at least enough so that indicia and preferably locking are revealed to the user so that the result of the quantum generator is exposed.

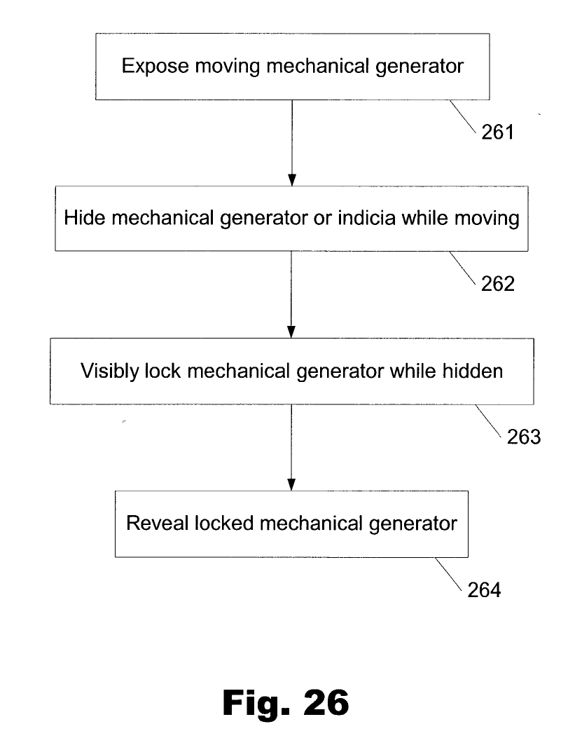

Turning now to FIG. 26, shown is a combination, block and flow diagram for exemplary embodiments of a visible motion quantum generator display and locking system in accordance with the teachings of the present invention. In particular four steps or boxes are shown as sequentially coupled. The first, box 261, calls for a mechanical generator display to be exposed while moving. Then box 262 recites the hiding of the actual indicator while it is moving and coming to a place of rest. Next step 263 is the preferably visible locking from further substantial change in configuration of the indicating element while still hidden. And finally step 264 is the revealing of the locked generator at least sufficient to reveal its configuration.

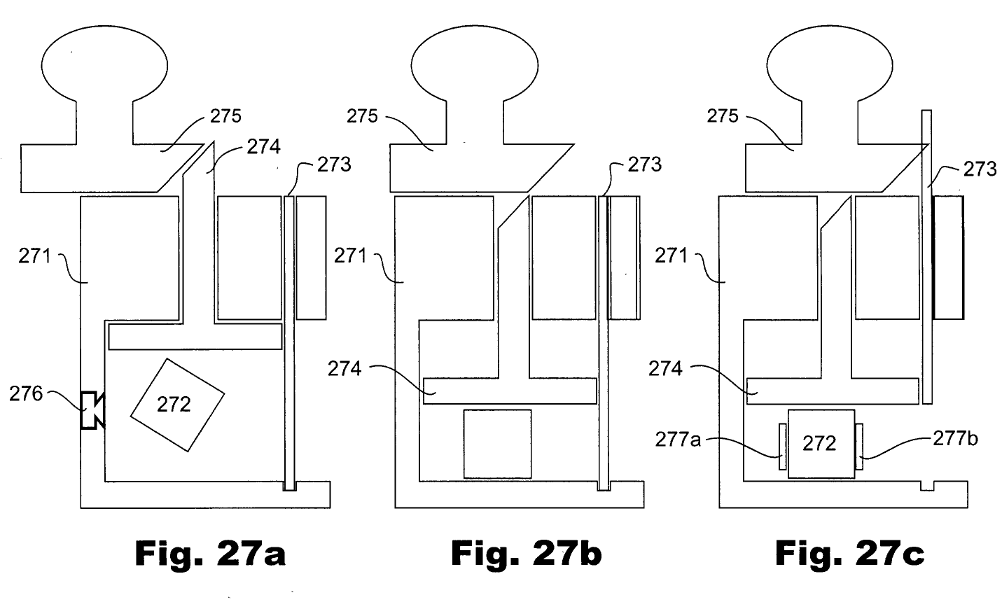

Turning now to FIG. 27a through 27c, shown are combination, block, functional, schematic, plan view diagrams for exemplary embodiments of a user-operable mechanical generator and locking system in accordance with the teachings of the present invention. FIG. 27a shows an example free movement while hidden state; 27b a locked while hidden state; and 27c a locked but revealed state. The mechanism is of stopper 274 and screen 273 slideably mounted in body 271 with handle 275 also constrained as shown. In particular, free element 272 bears indicia or otherwise determines outcomes by its position by means not shown for clarity. In the state of FIG. 27a it is free to change position and its position is changed unpredictably, such as by the user shaking the whole mechanism and/or by release of various stored energy and so forth being known in the art. Means, such as position detectors or sensor 276, as are well known in the art, preferably determine that the free element has entered a chaotic movement phase sufficient to prevent manipulation (and/or pre-positioning means, such as indicated by arms 277a and 277b orient free element 272 at a preferably random position shown in FIG. 27c that depicts an optional initial configuration preceding that of FIG. 27a in some preferred embodiments). At any time after this point, but preferably at the user's request, the stopper 274 is brought into a configuration that restrains element 272 in one of its distinct end configurations; also, user operable locking handle 275 is positioned (whether or not it urges handle 275 into position) so as to lock stopper 274 into this configuration. Finally, in FIG. 27c, hiding screen 273 is brought up and optionally but preferably handle 275 engages it and also holds it in said open position as shown.

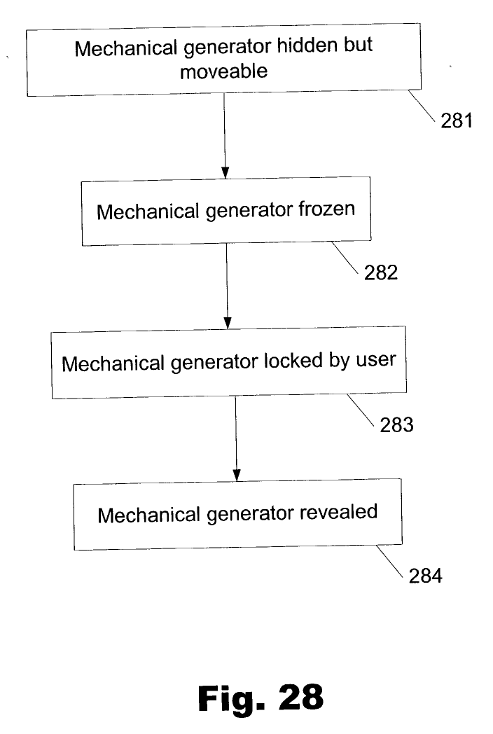

Turning now to FIG. 28, shown is a combination, block and flow diagram for exemplary embodiments of a user operable mechanical generator and locking system in accordance with the teachings of the present invention. Step 281 is the hiding of the mechanical generator in a free state; the user movement of it not indicated explicitly as it is externally supplied. Step 282 is the freezing in position of the generator; this is preferably after sufficient movement has been detected as indicated earlier. Next box 283 indicates the user act of locking the generator, which as already mentioned can be combined with the previous step. Finally, the configuration of the generator is revealed in step 284.

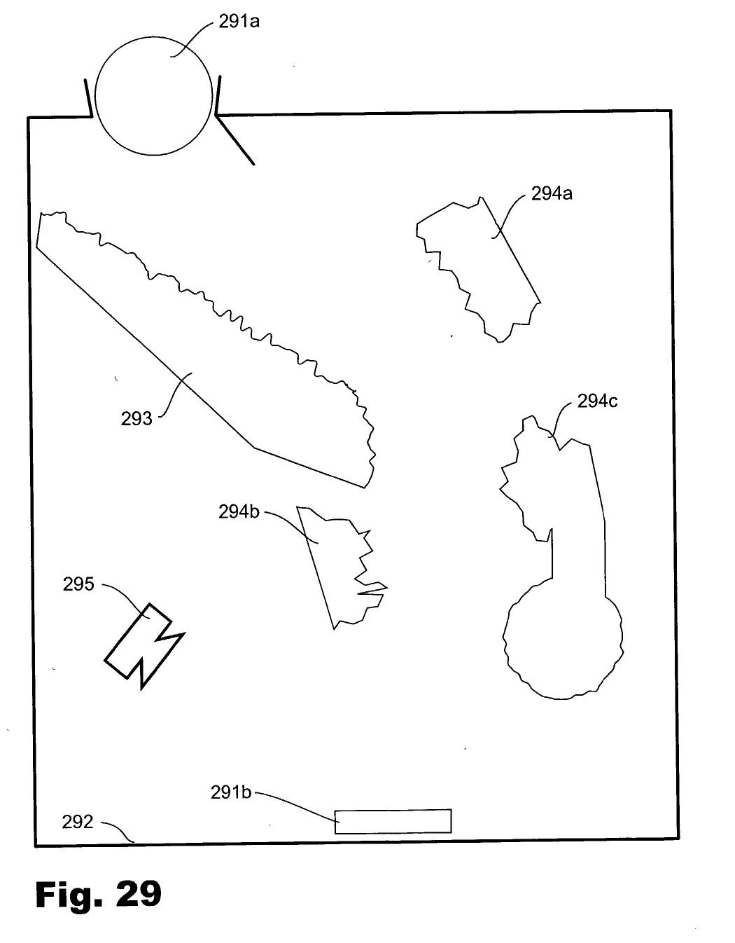

Turning now to FIG. 29, shown is a combination, block, functional, schematic, plan view diagrams for exemplary embodiments of a user operable mechanical generator and detector system in accordance with the teachings of the present invention. A user controlled physical random source that is believed not readily manipulated by skill is illustrated by an example where separate mechanical objects such as coins, dice or the like here called “tokens” 291 are inserted (as shown as token 291a) by a user. Although an opening in box 292 is shown for the entry point, various trapping entry stages, such as rotating doors, are known. Then token 291 falls against rough ramp 293 and is bounced around bumper barriers such as 294a, then 294b and 294c, before landing in the randomized sate 291b. Sensor/camera 295 then detects the orientation of the token, such as head/tails. (Other sensor means not shown for clarity can determine the validity of the token and that it does have the distinct faces, such as heads or tails or the six sides of a cube with the required indicia.)

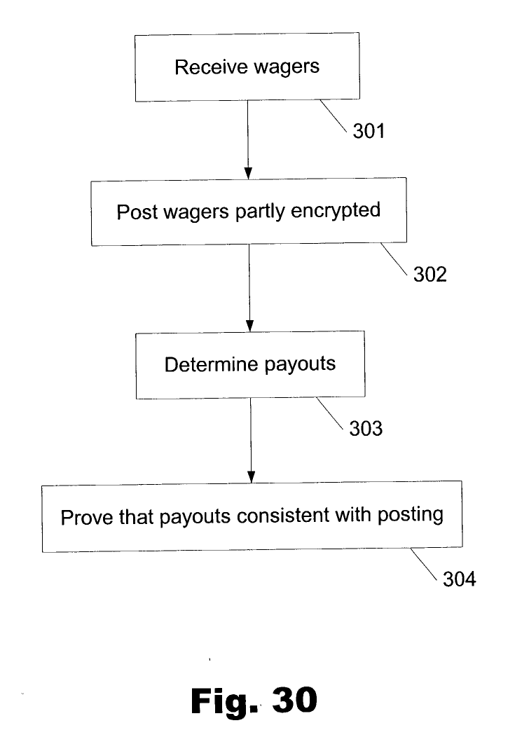

Turning finally now to FIG. 30, shown is a combination, block, functional, schematic, plan view diagrams for exemplary embodiments of system for accepting wagers, conducting experiments, and then making payouts in accordance with the teachings of the present invention. In the first step 301 the system receives wagers or bets from various players. These comprise, as is known, some form of identifying information, such as a serial number, physical chit of receipt, or identity or account or password of party placing the bet. In general, apart from simple raffles or the like where all bets are identical apart from who places them, typically additional information is included such as what outcomes are being bet on. Step 302 includes what will be called the “posting,” which can be publishing preferably on a web site or, in another example, recording on media or submitting to some form of time stamping service, the data sufficient to define what has been wagered on what outcomes, and preferably the identity of the wagers so that payouts can be made to the correct party. Next block 303 indicates that after the experiment, which may or may not be an internal part of the system, any payout are determined and made. Also, and in no particular time order, box 304 indicates that some form of cryptographic or other informational proof should preferably be made to at least interested parties that the wagers that were paid out were entitled to such payouts based on the amount wagered and other details of the bets. Additionally, but optionally, box 304 also includes proof where needed that all payouts deserved were made. What is also included in box 304 is known sorts of zero-knowledge or minimum-disclosure or other procedures that are convincing but that can hide some information that they are convincing about. As one illustrative example, the bets placed by those who lost can be hidden and never revealed. Similarly, if multiple bets could yield the same payout, those bets need not be distinguished. In examples it may be desired that user not obtain proof of how they bet, since for instance these could be used in other schemes and/or privacy should be provided; in such cases, proof could be offered that such a bet was not among the winning bets, but such proof would not reveal the exact bet. Also, where the identity of the bet is based, for instance, on a password or some other informational authenticator, a kind of “Swiss account” is created for the bet that can be paid out to the party first presenting the secret; a priori the system need not know the secret, however.

All manner of variations, modifications, equivalents, substitutions, simplifications, extensions, and so forth can readily be conceived relative to the present inventions by those of ordinary skill in the art. One example, as will be appreciated, is the types of elements used to illustrate mechanical experiments. Dice were used in some examples, but could readily be replaced by wheels bearing indicia or marked balls that find specific locations. For instance, balls could be positioned in cavities (potentially being held by position of elements visible from outside) in a glove box and then the covering later removed to reveal the values determined. Similarly, where wheels were used as an example, they could readily be replaced by elements with more degrees of freedom and even loose dice or balls, such as using glove boxes, known magnetic positioning techniques, random vibrations or air blasts. Accordingly, the scope of the inventive concepts herein disclosed should not be considered limited by the examples presented.

While these descriptions of the present invention have been given as examples, it will be appreciated by those of ordinary skill in the art that various modifications, alternate configurations and equivalents may be employed without departing from the spirit and scope of the present invention.

What is claimed is:

1. A random number generation system method comprising:
hiding substantially from view of at least one user at least one indicia bearing element;
first positioning of said indicia bearing element relative to other elements to introduce a first random positioning;
allowing said at least one user to introduce second positioning at least influencing the interpretation of said first positioning of said at least one indicia bearing element; and
revealing to at least said user at least said first positioning of said at least one indicia bearing element.

2. In the method of claim 1:
said first positioning and said second positioning influencing positioning of at least one of same said at least one elements.

3. In the method of claim 1:
said first positioning and said second positioning being combined by an Abelian group operation.

4. In the method of claim 1:
said first positioning being determined by at least one remote entity.

5. In the method of claim 1:
plural entities contributing to said first positioning in such a way that subsets of the plural entities below a pre-arranged subset threshold are prevented from learning said first positioning until after said second positioning.

6. In the method of claim 5:
messages from plural pre-determined quorums of said plural entities being sufficient to determine said first positioning.

7. In the method of claim 1:
said second positioning being substantially beyond the ability of an ordinary user to deliberately determine.

8. In the method of claim 1:
locking said first positioning in a way perceivable to said at least one user and before at least substantially said second positioning.

9. In the method of claim 1:
locking said second positioning in a way perceivable to said at least one user and at least substantially before said revealing.

10. A gaming machine comprising:
plural tokens;
user insertion of tokens into said machine;
randomizing means, substantially beyond the control of users of ordinary skill, of the approach to resting position of said tokens;
sensors to determine the orientation of said tokens in said resting position; and
consequences for users depending at least in part on at least some of said resting positions of said tokens.

11. In the gaming machine of claim 10, including:
sensors to detect invalid tokens.

12. A random value creation method comprising the steps of:
plural parties each supplying a single transmission from which a resulting random value is derived.

13. In the random value creation method of claim 12:
determining said resulting random value by combining signatures on common input;
and said signatures supplied in said transmissions.

14. In the random value creation method of claim 12:
arranging said transmission paths so that parties have substantially insufficient time to alter their own said respective said transmissions responsive to said transmissions of others.

15. A system for accepting wagers, conducting experiments, and then making payouts, comprising:
posting for public inspection plural wagers at least some of said wagers having at least parts that are encrypted;
at least obtaining the results of conducting of the experiment;
making payouts determined by said posted wagers and at least in part by said encrypted parts; and
establishing at least that said encrypted parts are consistent with said payouts.

16. In the system for accepting wagers, conducting experiments, and then making payouts of claim 15:
an auditing system that allows payments received to be verified against particular wagers and payout amounts to be checked as being correctly determined by amounts and other wager details as determined in said posting.

17. In the system for accepting wagers, conducting experiments, and then making payouts of claim 16:
a cryptographic hiding of at least some values while allowing said checking to be convincing to the public.

18. In the system for accepting wagers, conducting experiments, and then making payouts of claim 15:
hiding substantially from view of at least one user at least one indicia bearing element;
first positioning of said indicia bearing element relative to other elements to introduce a first random positioning;
allowing said at least one user to introduce second positioning at least influencing the interpretation of said first positioning of said at least one indicia bearing element; and
revealing to at least said user at least said first positioning of said at least one indicia bearing element.

19. In the system for accepting wagers, conducting experiments, and then making payouts of claim 15:
plural parties each supplying a single transmission from which a resulting random value is derived.
